(19) United States
(12) Patent Application Publication
(10) Pub. No.: US 2018/0372458 A1
(43) Pub. Date: Dec. 27, 2018

(54) SYSTEM, METHOD AND SOFTWARE BASED MEDIUM FOR PRODUCING A TARGET SHEET EMBEDDED WITH SENSOR TECHNOLOGY AND COMMUNICATING WITH A REMOTE SMART DEVICE FOR REAL TIME DATA CAPTURE, TRACKING AND COMPARISON

(71) Applicant: Brian Janssen, Brookfield, WI (US)

(72) Inventor: Brian Janssen, Brookfield, WI (US)

(21) Appl. No.: 16/014,478

(22) Filed: Jun. 21, 2018

Related U.S. Application Data
(60) Provisional application No. 62/522,952, filed on Jun. 21, 2017.

(51) Int. Cl. F41J 5/04; H04W 4/80; F41J 5/14; F41G 3/26

(52) U.S. Cl. CPC F41J 5/042; H04W 4/80; F41J 11/00; F41G 3/26; F41J 5/14

(57) ABSTRACT

A system, method and computer readable medium for providing real time feedback of ballistic impact of a target utilizing a sensor sheet which signals a ballistic impact event as data communicated to a remote device, not limited to a mobile application enabled smartphone, smartwatch, laptop, tablet or other digital and audio/visual display device. In response to an impact by the ballistic, the sensor sheet communicates to a sensor of the remote device a signal corresponding to a location associated with the location of ballistic impact. Additional biometric enabled or pressure/grip sensors in use with a glove or other enabled device/attachment can work in concert the target sensor in a dynamic target environment, such including time synchronized projected image changes with target identification to simulate and record live fire performances.

### CROSS REFERENCE TO RELATED APPLICATIONS

The present application claims priority from U.S. Ser. No. 62/522,952 filed Jun. 21, 2017.

### FIELD OF THE INVENTION

The present invention relates generally to target practice involving the firing of live ammunition at a distant target and in overcoming the difficulties in electronically recording results for real time display and tracking and session performance archiving and retrieval. More specifically, the present invention discloses a system, method and software based medium for providing real time feedback of ballistic impact of a remote target utilizing a sensor impregnated sheet integrated into the target display and which signals impact of a bullet via an associated control platform to transmit real time data to a remote device not limited to a processor, mobile application enabled smartphone, smartwatch or the like.

### BACKGROUND OF THE INVENTION

The prior art is documented with examples of ballistic indicating devices for determining shot pattern and placement. Current recording devices utilize after the fact manual overlay and picture capture technology for determining shot placement. Other camera recording systems are also known, such as which can be positioned close to the target.

Other notable references include the projectile target system of Kazakov U.S. Pat. No. 9,004,490 which teaches a projectile target having a substantially sealed chamber with a front face and a rear face with an enclosing side wall disposed intermediate. The front and rear faces are formed by membranes configured to allow a projectile to pass through and then substantially seal to maintain the substantially sealed chamber. Pressure wave sensors are disposed within the chamber and are configured to detect pressure waves created by the projectile. A target controller receives signals from the pressure sensors indicative of the pressure sensed by the sensors and determines an impact point of the projectile on the front face of the target.

US 2015/0123346, to Mason, teaches a remote targeting apparatus and method including a projectile target with a sensor array for computing projectile impact data and transmitting the data by a controller, as well as displaying information corresponding to the data. RF transmission/reception is performed, most preferably at a frequency of between approximately 902 and 928 MHz, with the controller having RF Faraday cage shielding and collision avoidance being employed to permit multiple sensor arrays to operate in a vicinity of one another. Projectile impact locations are provided within twelve inches of the center of the projectile target and are calculated to an average RMS accuracy of less than approximately fifty thousandths of an inch, directly in an orthogonal Cartesian coordinate system. Velocity is also determined via an additional sensor at a predetermined distance from the sensor array which measures a difference in time between the projectile passing the additional sensor and the sensor array. The preferred sensor array has at least two pairs of acoustical sensors, with an additional acoustical transducer orthogonal to the two pairs.

US 2009/0102129, to ISOZ et al, discloses a shooting target system having a target including a material in which shock waves arise and propagate when hit by a projectile. A first shock sensor is arranged to detect the shock waves. At least a second shock sensor is arranged at a distance from the first shock sensor. A calculation module is configured to determine at least a first time-delay between the detections of the shock wave by the first and the at least second sensor, and to calculate information relating to the point of impact of the projectile in the target based on the at least first time-delay.

U.S. Pat. No. 5,092,607, to Ramsay et al., teaches a ballistic impact indicator for alerting a marksman that a bullet has struck a target and includes a vibration sensor mounted to an adjustable clamp for removably securing the vibration sensor to target board. The vibration sensor is electrically coupled by a connector cable to a controller circuit for operating a xenon flash tube strobe light.

In response to a detection of an impact by the vibration sensor, the controller circuit generates a delayed trigger signal, the delay of which can be selected by the user between approximately 2 and 6 seconds, for triggering the strobe light. The controller circuit also causes the strobe light to flash repeatedly if either the vibration sensor or connector cable are hit by a bullet. The sensitivity of the vibration sensor is adjustable in accordance with the energy of the bullet and wind conditions. The strobe light and controller circuit are powered by a rechargeable storage battery to provide a portable unit.

### SUMMARY OF THE PRESENT INVENTION

The present invention discloses a system, method and computer readable medium for providing real time feedback of ballistic impact of a remote target utilizing a sensor impregnated sheet and which signals a ballistic impact event as data transmitted to a remote device, such further including but not limited to a mobile application enabled smartphone, smartwatch, laptop, tablet or other digital and audio/visual display device. The sensor sheet further includes a circuit or circuit array of multiple sub-circuits. In one exemplary and non-limiting embodiment, the circuit, sensor or sensor array is interrogated by the response recorder components associated with the present design and, in response to an impact by the ballistic at a given location, an algorithm takes the pre and post shot sensor conditional information and processes it to determine the xy coordinates corresponding to the location of impact. The mapping process/algorithms employed align the impact location with a corresponding generated image location. Following this, an operatively connected transmitter outputs a signal corresponding to the location associated with circuit location which is damaged by the ballistic impact. The ballistic information gathered is recorded or otherwise presented, compiled or utilized in any fashion desired for purposes of training/instruction, comparison or assessment.

The varieties of sensors may further include any of a wireless, connection-free inductor or capacitor sensor system (the sensor sheet exhibiting any of a rigid, partially flexible or substantially flexible cloth, membrane, or other substrate material according to any shape or dimension and with an imprinted or other conductively applied circuit pattern). Other sensor varieties include UHF (ultra-high frequency) passive RFID (radio frequency identification) tags and/or carbon nanotube designs also potentially utilizing a variety of substrates, thin film materials, paper, bucky paper and the like. A target integrating the circuit array may further broadly encompass any of wiring, printed circuits or conductive ink applications which can include an excitation frequency registering the impact location. As will be described in further detail, specific sensor variants (such as the conductor capacitor versions) can include any variety of sensor sizes, shapes, line thicknesses and gap spacing.

A mini-chip processor can be integrated into the sheet and in communication with the operatively connected transmitter. A wireless communication protocol of some type is also provided for transmitting data to the remote device and can include, without limitation, any of a Bluetooth, Near Field Communication, ZigBee, WiFi or other protocol.

Other features include any algorithmic protocol for providing data additional to real-time point of impact and including any of replay, review and analysis, summary statistics, visual images of performance and session to session comparison.

The present assembly further includes any of a variety of input sensors, including biometric enabled, pressure/grip sensors in use with a glove or other enabled device/attachment. A further related variant of the invention, such as which can work in concert with the arrangement of biometric, proximity or other input sensor capabilities, can further include the incorporation of the sensor and protocols into a dynamic target environment, such including time synchronized projected image changes with target identification, this in order to simulate and record live fire performances. This can include numerous applications such as for any of military, law enforcement/SWAT or other training and evaluation exercises.

### BRIEF DESCRIPTION OF THE DRAWINGS

Reference will now be made to the attached drawings, when read in combination with the following detailed description, wherein like reference numerals refer to like parts throughout the several views, and in which:

FIGS. 1A-1C present a series of views of a target sheet incorporating a sensor insert according to the present invention and which can be paired to a remote processor and display device, such as a mobile application enabled phone or tablet, and via a control platform for providing real time display, tracking, comparison and analysis of targeting results, and with FIG. 1A depicting a pre-shot view of the smart target and acquisition system, FIG. 1B an environmental view of a shot being fired by an individual at the target, and FIG. 1C a post-shot view similar to FIG. 1A showing a visual (as well as separately recordable and visually representable) depiction of the impact results of the target practice;

FIG. 1D is an illustration of a mobile application enabled smartphone for depicting target impact results, and including all of response output, notification and event recordation functionality, according to one application of the invention;

FIG. 1E is similar to FIG. 1D and depicting a target representation on a smart watch in place (as well as in addition to) of the mobile phone;

FIG. 1F is another illustration similar to FIG. 1D of a tablet computer;

FIG. 1G is yet another illustration similar to FIG. 1D of a laptop computer;

FIGS. 2A-2I provide a series of illustrations of individual sensor elements, such as which are integrated in a grid defined plurality into a target sheet and which are selected from each of wireless, connection-free inductor/capacitor sensors including single or multiple sensor elements (these being broken upon impact into a pair of or larger plurality of smaller sensor elements), as well as examples of passive RFID tag sensor assemblies, carbon nanotube, graphene and/or other thin film membrane material sensor assemblies;

FIG. 3A is an illustration of one example of a target sensor sheet, each of the individual sensor elements having a central located RFID or inductor capacitor components, and which are enlarged to an exaggerated degree for purpose of clarity of illustration and over which is superimposed in phantom a representation of concentric target circles;

FIG. 3B is an illustration similar to FIG. 3A of a further version of an inductor/capacitor sensor sheet, the sensor elements again being shown in exaggerated fashion in one non limiting application and including a winding wire or filament which terminates at a central interior location;

FIG. 4A is an illustration of another example of a target sensor sheet incorporating any version of carbon nanotube, graphene or other conductive and thin film membrane such as bucky paper for identifying and outputting an impact location such as associated with a firearm projectile (bullet, arrow, etc.);

FIG. 4B is an enlarged partial illustration taken from FIG. 4A of a selected section of the conductive membrane design shown in non-limiting fashion;

FIG. 5 is an illustration of an example of response and recorder protocol in which a sensor element impact location is communicated with a magnetic field response recorder component for assisting in recording and depicting an impact location of the projectile;

FIGS. 6A and 6B provide first and second depictions of a simplified arrangement of the functionality of the magnetic field response recorder which is alternative to that shown in FIG. 5 and depicting the both a single sensor element (FIG. 6A) and a target sheet with plurality of (size exaggerated) elements (FIG. 6B);

FIGS. 7A and 7B provide first and second illustrations of response recorder scenarios in which the target sheet is provided with embedded antennae;

FIGS. 8A and 8B are depict a response recorder detection protocol according to each of pre-impact and post-impact conditions, including depictions of the variations in the frequency response component of the field response recorder, with location analyzer output;

FIGS. 9-10 are front and back views of a combination image and sensor sheet version in which the image is depicted applied to a forward facing side and the sensor array to an opposite rear side, such including provision of a single sheet with the sensor(s) and images on opposite sides thereof;

FIGS. 10A-10C provide illustrations of varying examples of target sheet size and layout configuration provided via sensor image coordinate mapping capabilities;

FIG. 11 is an exploded illustration of a target sheet overlaying a sensor array base (conductive element sheet or other) of one non-limiting variety, such also including utilizing a single sheet with a sensor array imprinted on one side and an image on an opposite side;

FIG. 11A is an illustration of a target sheet with designated impact location within the sensor grid array;

FIG. 11B is a side partial and cutaway view of the impact location depicted in FIG. 11A of the given sensor element;

FIG. 11C is an illustration of the target sheet of FIG. 11A exhibiting an adaptation for supporting multi-shot, single location detection and which additionally includes an outer strip or perimeter edge (non-grid location support) such as including an integrated piezo film, or other component for providing detection of any of a shot landing outside of the sensor grid array as well as detecting same location shots;

FIG. 11D illustrates a non-grid sensor impact location of a projectile corresponding with the representation in FIG. 11C and in which the outer piezo film or other material provides multi-layer circuit completion by the projecting bridging the spaced apart sheet conductive layers;

FIG. 12 is a system process overview flow diagram of a target and range management protocol incorporated into the present system, process and processor enabled-computer readable medium and covering each of setup, acquisition (impact event recording) and post session (date compilation, storage and presentation) subset functions;

FIG. 13 is a further flow diagram of system components associated with the target and range management functions of the present invention and including each of target location, detection and identification, target acquisition systems, collection inputs/devices, user interface(s), system control/management, data management and analytics, recording and reporting functions;

FIG. 14A provides a pair of pre-impact and post-impact representations of a target depiction on such as a processor enabled and wirelessly communicating smart watch (see also FIG. 1E);

FIG. 14B provides a series of depictions of event representations upon an mobile phone (see also FIG. 1D) including each of target depiction, control platform illustration and data output compilation;

FIG. 14C provides a further depiction similar to FIGS. 14A-14B utilizing any of a laptop or desktop processor controlled and connected device;

FIGS. 15A-15B illustrate a pair of depictions of integrated biometric sensors and readout functionality, such providing each of motion tracking (pre and post shot) and biometric and environmental measurements and which can be synchronized with any version of the targeting and display system for proving visual, auditory and haptic feedback of real time results of ballistic impact on the target positioned sensor sheet and collecting shooter and environmental information;

FIGS. 16A-16B illustrate a pair of depictions of a biometric enabled glove (FIG. 16A) and a sensor enabled gunstock (FIG. 16B) for providing any one or more of respiration, heart rate, blood pressure, electromyography, epidermal (sweat) activity, motion detection, pressure detection, RFID, Bluetooth, ZigBee, ANT, WiFi, sound, vibration and summary graphs;

FIG. 17A is an illustration of a target acquisition configuration including a single use target with integrated power, detection and communications functionality;

FIG. 17B is an illustration of a further variant of a target acquisition configuration in the form of an interface clipped onto the target sheet, such as including a single use target with battery powered reusable detection and communications;

FIG. 17C is a yet further illustration of another variant of a target acquisition configuration with built-in range target retrieval interface, such as including a single use target with permanent, powered detection and communications and including a traversing trolley or carriage mount at an upper end for displacing the target between use and reference/inspection positions;

FIGS. 18A and 18B provide a pair of exemplary dynamic image projection target displays, such as integrating any of the functionalities depicted in FIGS. 17A-17C and which can be utilized in combination with the biometric and input sensor functionality of FIGS. 15A-16B for use in such as a dynamic target practice or like exercise; and

FIG. 19 is an environmental illustration of a dynamic target image projection and acquisition scenario utilizing the displays of FIGS. 18A-18B providing time synchronized projected image changes with target impact identification capabilities for simulating and recording participant performance such as random friend/foe changes in the target representations.

### DETAILED DESCRIPTION OF THE PREFERRED EMBODIMENTS

As previously described, the present invention discloses a system, method and software based medium for providing real time feedback of ballistic impact of a remote target utilizing a sensor sheet integrated or otherwise incorporated into the target display and which signals impact of a bullet, with an associated control platform transmitting real time data to a remote device not limited to a processor, mobile application enabled smart phone or the like. In this fashion, the present invention seeks to provide an effective mechanism for utilizing any type of circuit embedded arrangement within a target sensor sheet which is responsive to a ballistic impact event (not limited to a cartridge discharged bullet but also including any type of arrow or other projecting) associated with target practice and for providing real-time display, tracking, analysis and comparison of target accuracy.

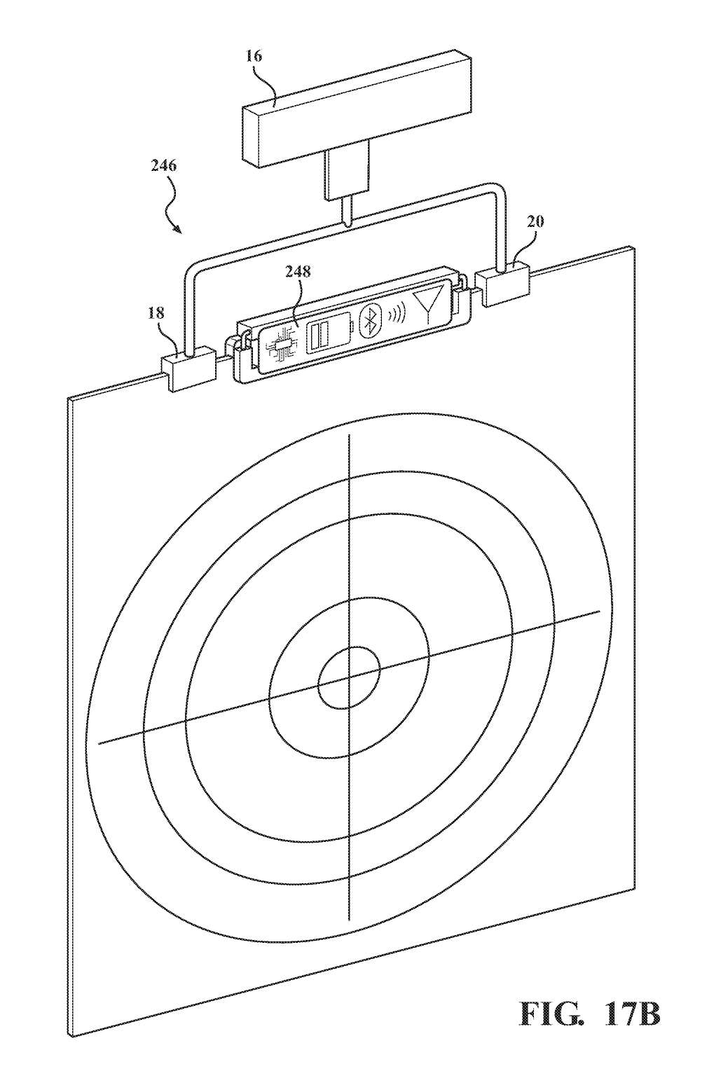

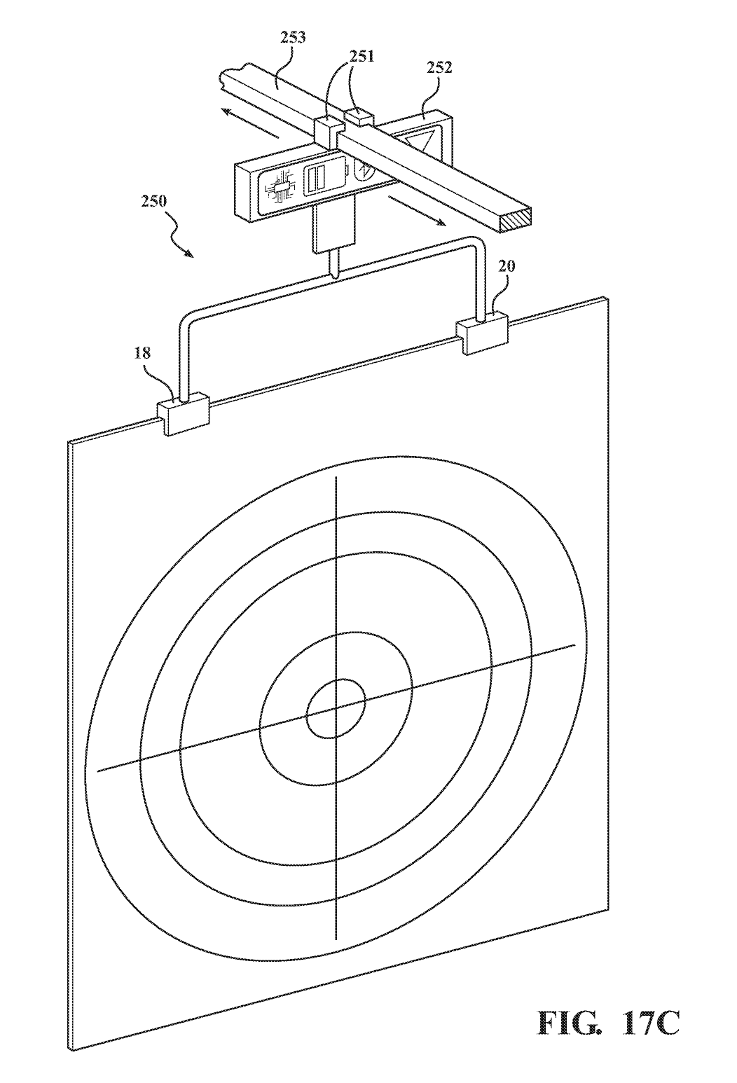

The present invention further contemplates, in one non-limiting variant, providing a target sheet (can be inexpensive) which is embedded with the appropriate sensor technology, future reference also being made to the alternate variants depicted in FIGS. 17A-17C (such as including a circuit grid) and which can identify where (and when) the target is struck by a ballistic impact. As will be further described, the target can be paired, via an appropriate wireless or other communication protocol, with a response recorder component which is integrated into a remote processor driven device (smartphone, smart watch, tablet, laptop, other digital device with screen display) and, in response to the protocol established between the detection and communication component associated with the sensor sheet and the remote located processor, provides both detection and determination of shot location, real time capture of target data, as well as real time feedback of a shooting session via any of audible and/or visual feedback, including personalized wearable devices which can provide indication of target results, such including any configuration combination for visually showing or highlighting impact and providing an audible sound, vibration, buzzer or the like when a specific part of the target is hit. As will also be described, the associated control platform and algorithmic protocols of the processor can provide each of comparison and tracking mechanisms for determining accuracy.

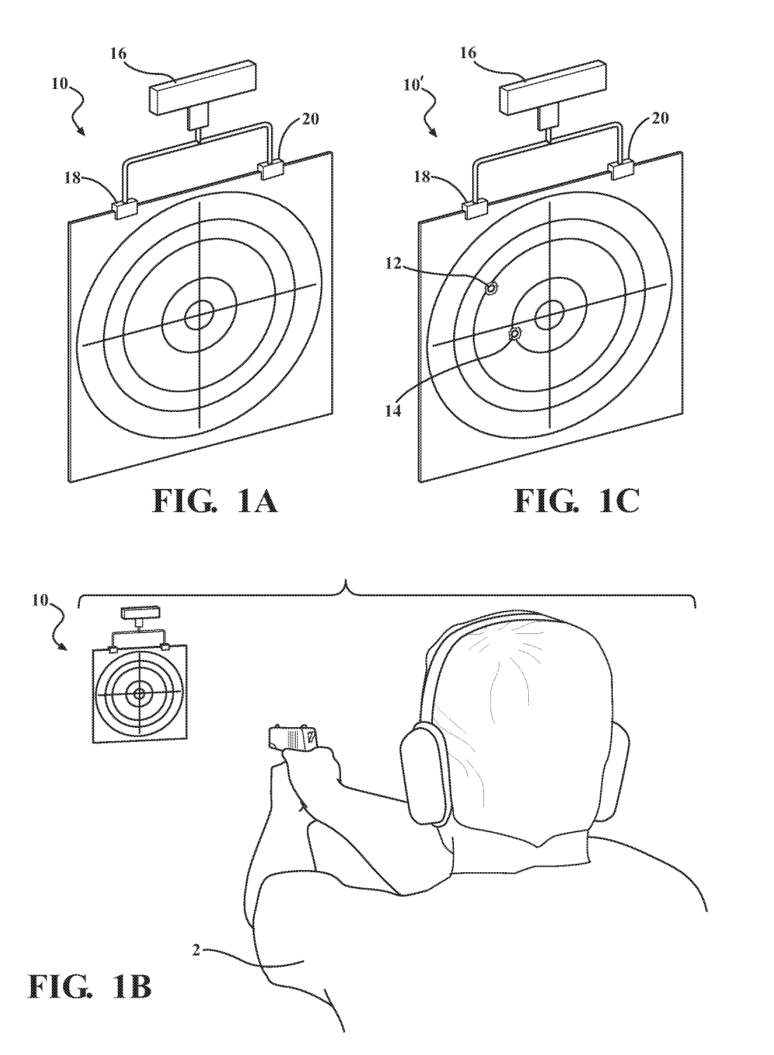

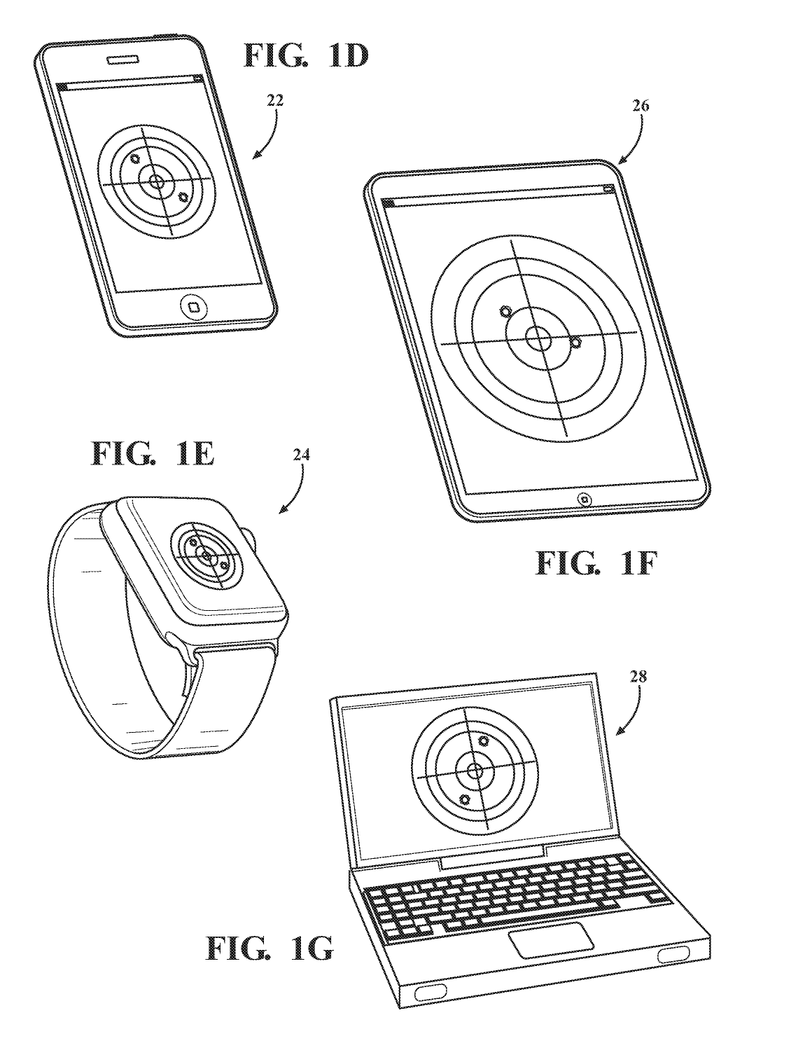

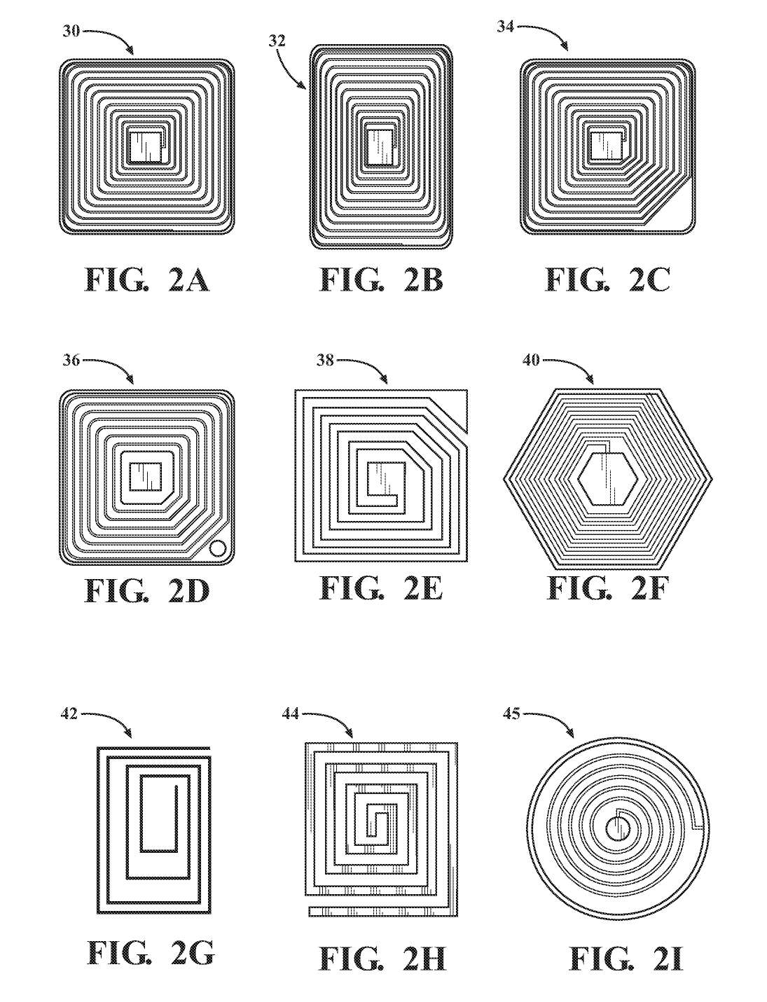

FIGS. 1A-1C present a series of views of a target sheet incorporating a sensor insert according to the present invention and which can be paired to a remote processor and display device, such as a mobile application enabled phone or tablet, and via a control platform for providing real time display, tracking, comparison and analysis of targeting results, and with FIG. 1A depicting, generally at 10, a pre-shot view of the smart target and acquisition system, FIG. 1B an environmental view of a shot being fired by an individual 2 at the target 10, and FIG. 1C a post-shot view 10′ similar to FIG. 1A showing a visual (as well as separately recordable and visually representable) depiction of the impact results, further at 12, 14, et seq. of the target.

As further depicted in FIGS. 1A and 1C, the target 10 can also include a self-powered pairing and transmitting device 16. Contact points, at 18 and 20, are also provided for powering the sensor embedded target and device to an electrified rail or the like.

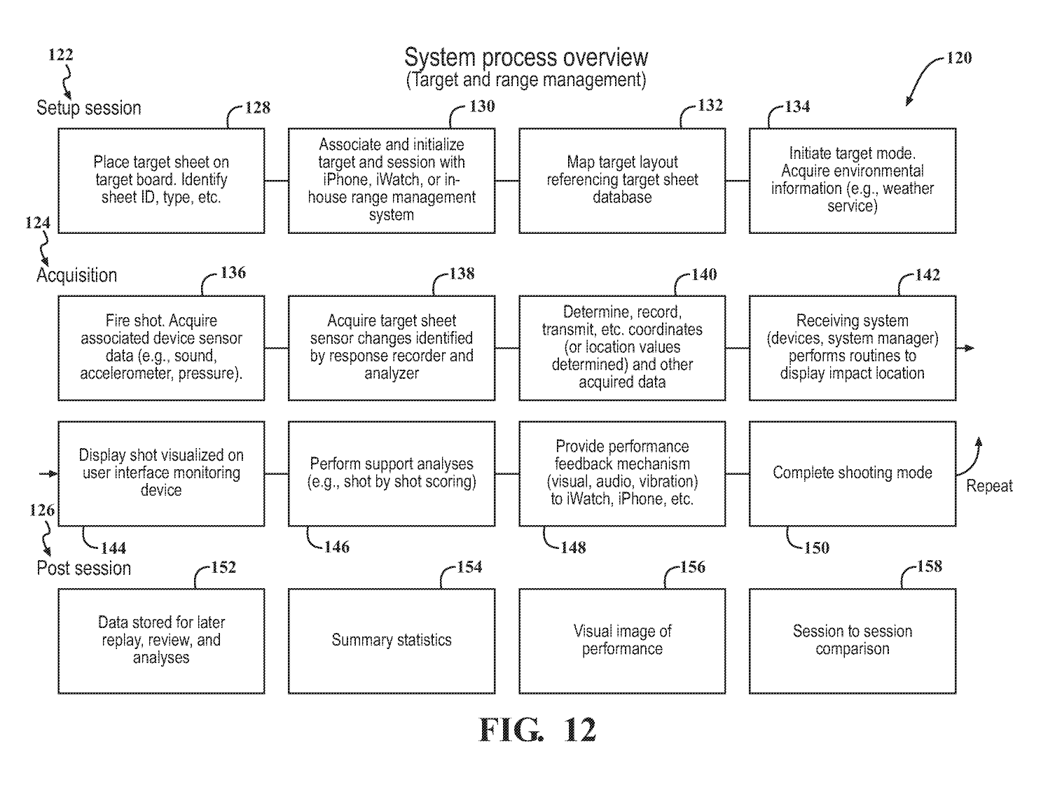

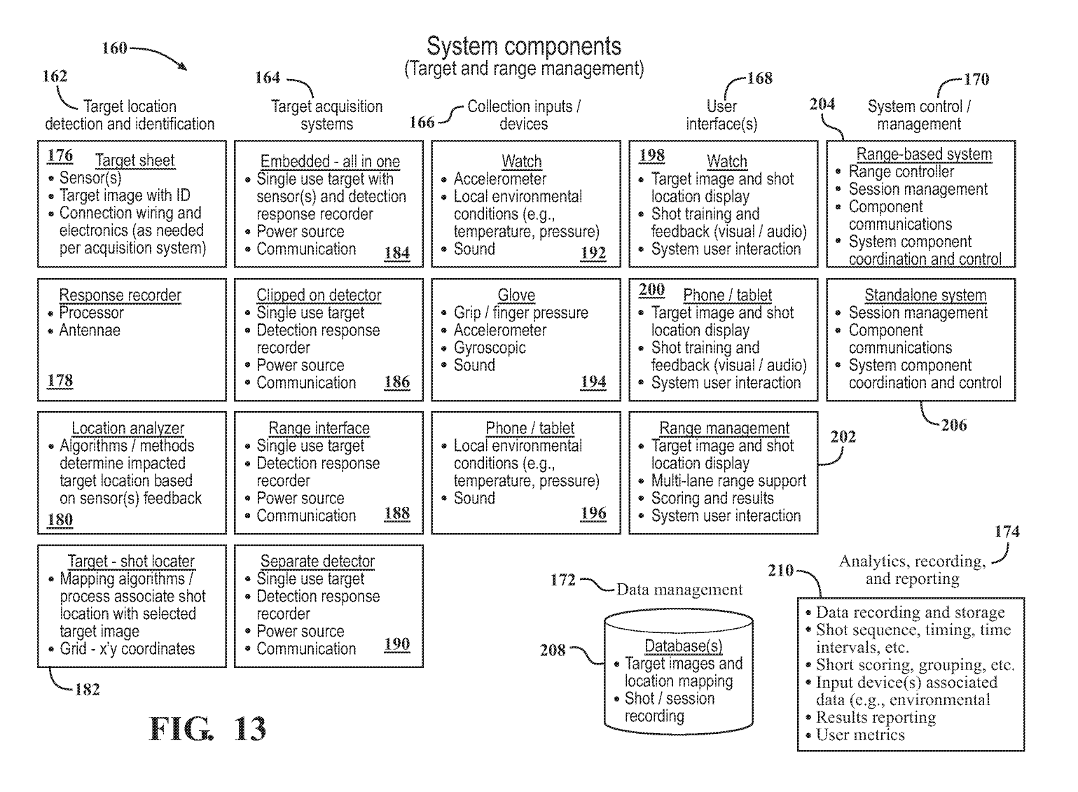

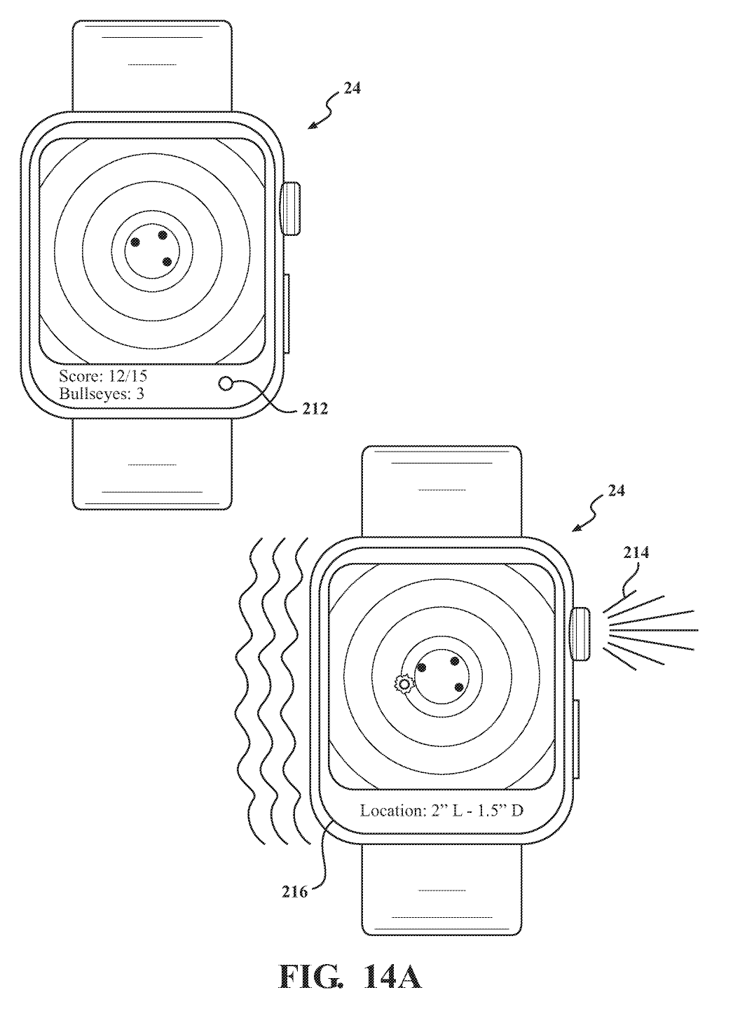

FIG. 1D is an illustration of a mobile application enabled smartphone 22 for depicting target impact results, and including all of response output, notification and event recordation functionality, according to one application of the invention (these being subsequently described with reference to the system process overflow of FIG. 12 and the related system components of FIG. 13. FIG. 1E is similar to FIG. 1D and depicts a target representation on a smart watch 24 which can operate in place of (as well as in addition to) of the mobile phone, such being paired together as is known in the art. FIG. 1F is another illustration similar to FIG. 1D of a tablet computer 26 and FIG. 1G is yet another illustration similar to FIG. 1D of a laptop computer 28. The illustrations of FIGS. 1D-1G are understood to represent non-limiting examples of any type of processor driven and visual depicting output devices which can operate in wired/wireless communication with the target assembly 10 in order to quickly record, respond and output (such as visually depicting shot placement of a projectile on the target), this again in addition to other data compilation, notification, recording and storage functionalities.

FIGS. 2A-2I provide a series of illustrations of individual sensor elements (see as shown at each of 30, 32, 34, 36, 38, 40, 42, 44 and 45, respectively). Each of the sensor sheet arrays, without limitation, can be provided as a single large sensor element with a continuous winding filament (see in particular FIGS. 2G and 2H) or can incorporate a large plurality of smaller sized individual elements (these understood to not be limited to any dimensional range, pattern, design, filament/tracing width or filament/tracing gap spacing), which are integrated in a grid defined plurality target sheet and which are selected from each of wireless, connection-free inductor/capacitor sensors, passive RFID tags (see as depicting a central component associated with each of the examples of FIGS. 2A-2F and 2I). Additional examples of sensors are envisioned and which can include any carbon nanotube, graphene and/or other thin film membrane materials.

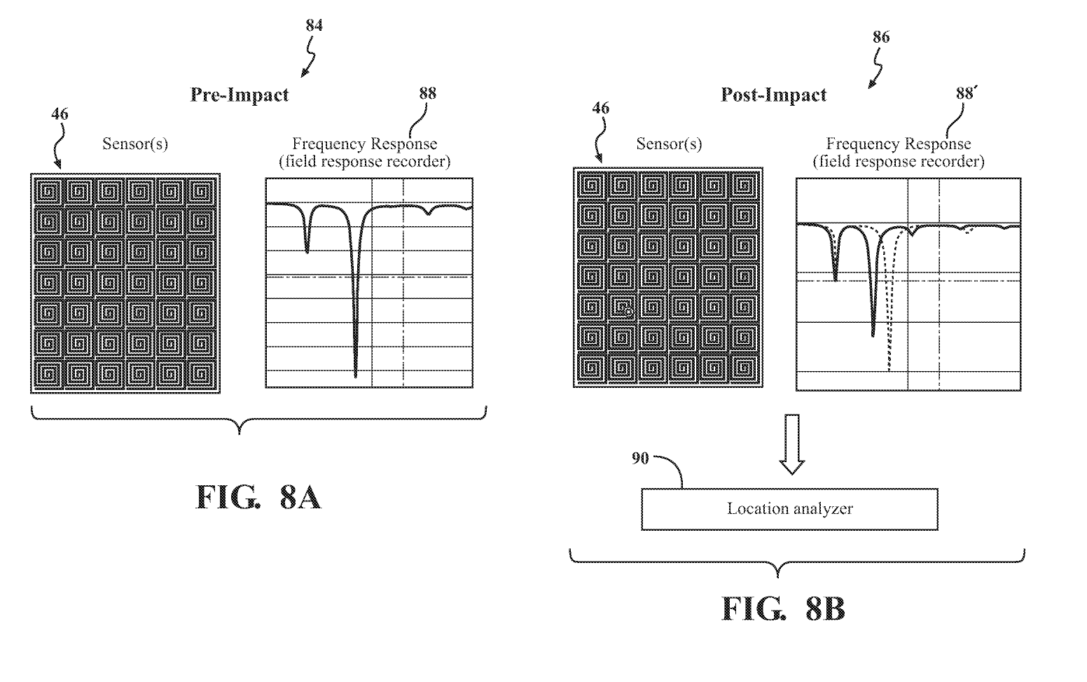

In the instance of a multi-sensor solution, it is also envisioned that the designs shown can also vary slightly from one sensor element to another within the same sheet. The sensors (notably those of the inductor/capacitor or RFID variety) can also be printed such as with any of an embedded circuit design, as well as a conductive ink or conductive inductor tracings. In the latter instance, the conductive ink can function as a detection communication component associated with the target sheet and, in response to the excitation of a frequency resulting from communication with a remote processor supported frequency response recorder (see FIGS. 8A-8B), communicates to the processor an impact or damage location thereof corresponding to the impact location.

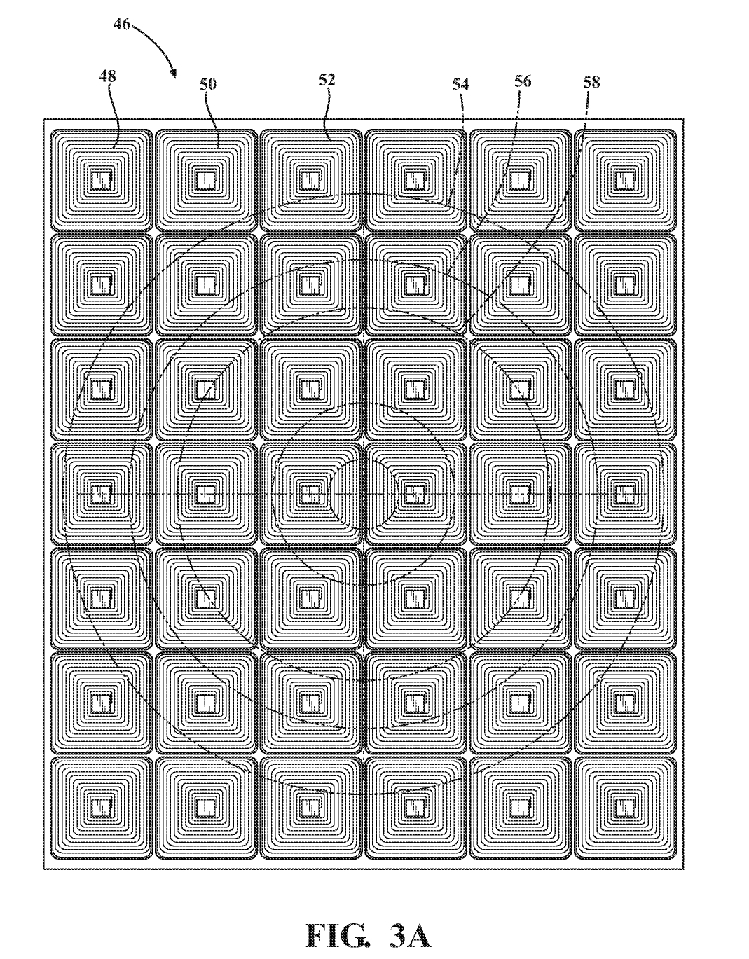

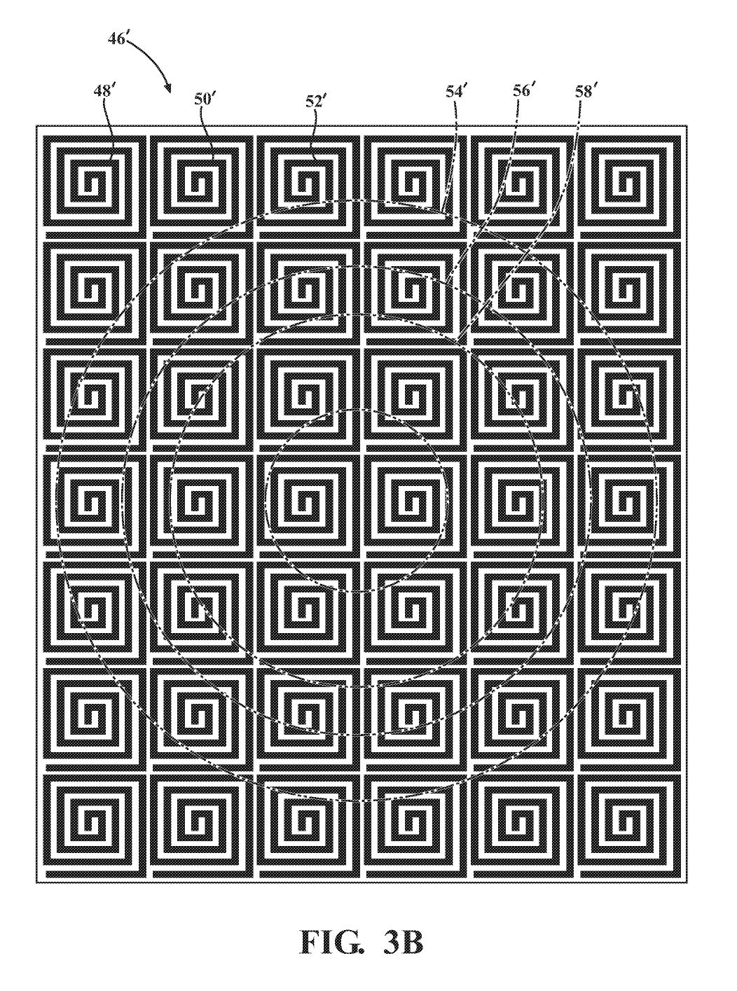

FIG. 3A is an illustration of one example of a target sensor sheet, generally at 46, the individual elements, see at 48, 50, 52, et seq., are shown enlarged to an exaggerated degree for purpose of clarity of illustration and over which is superimposed in phantom a representation of concentric target circles, further at 54, 56, 58, et seq. By comparison, FIG. 3B is an illustration similar to FIG. 3A of a further version of an inductor/capacitor sensor sheet, at 46′, with a version of the sensor elements 48′, 50′, 52′, et seq., these exhibiting the inductor/capacitor winding patterns, and which are again shown in exaggerated fashion. As with FIG. 3A, shown in phantom is a representation of concentric target circles, at 54′, 56′, 58′, et seq. superimposed over the sensor array shown.

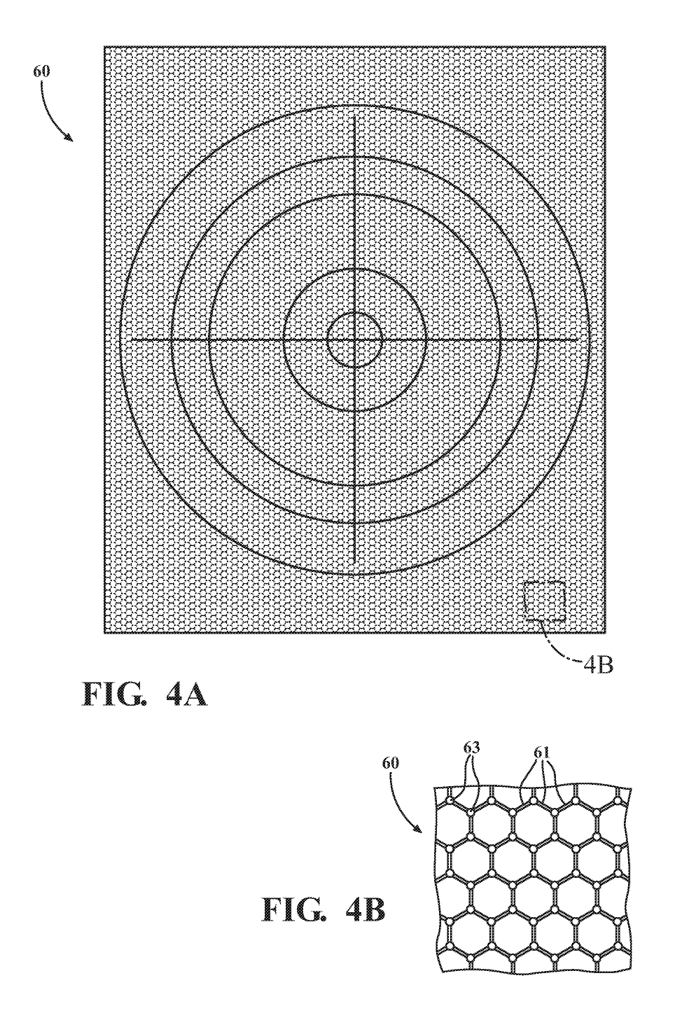

FIGS. 4A and 4B provide an illustration of another example of a target sensor sheet, at 60, and incorporating any version of carbon nanotube, graphene or other conductive and thin film membranes for identifying and outputting an impact location such as associated with a firearm projectile (bullet, arrow, etc.). The enlarged inset view of FIG. 4B illustrates a portion of the carbon nanotube pattern shown in FIG. 4A, this further depicting microscopic sized links 61 and interconnecting nodes 63. It is further understood that, with reference again to FIG. 4A, the latticework pattern referenced is actually much smaller (more microscopic) than depicted for purposes of ease of illustration.

Carbon nanotubes, also called Bucky tubes, are nanoscale hollow tubes composed of carbon atoms. The cylindrical carbon molecules feature high aspect ratios (length-to-diameter values) typically above 10³, with diameters from about 1 nanometer up to tens of nanometers and lengths up to millimeters. The unique one-dimensional structure and concomitant properties endow carbon nanotubes with special natures, rendering them with unlimited potential in nanotechnology-associated applications. Carbon nanotubes are members of the fullerene family.

Single walled carbon nanotubes (SWNT's) can be described as a long tube formed by wrapping a single graphene sheet into a cylinder with diameter of about 1 nanometer, the ends of which are capped by fullerene cages. The fullerene structures, with alternating structures of five hexagons adjacent to one pentagon, form the surface with desired curvature to enclose the volume. The sidewalls of carbon nanotubes are made of graphene sheets consisting of neighboring hexagonal cells.

Multi-walled nanototubes (MWNT's) are concentrically aligned SWNT assemblies with different diameters. The distance between adjacent shells is about 0.34 nanometer. MWNTs differ from SWNTs not only in their dimensions, but also in their corresponding properties. Various techniques have been developed to produce carbon nanotubes in sizable quantity, high yield, and purity, while maintaining a reasonable cost. Well-developed techniques include arc discharge, laser ablation, and chemical vapor deposition (CVD), and most processes involve costly vacuum conditions.

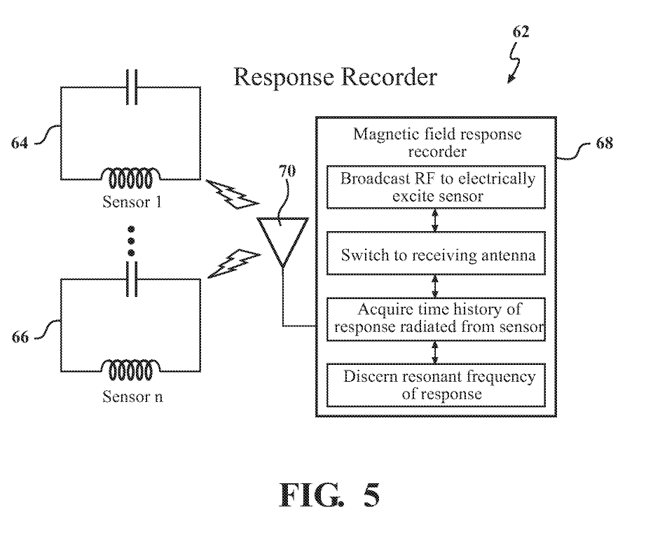

Proceeding to FIG. 5, an illustration is generally shown at 62 of one non-limiting example of a response and recorder protocol in which a sensor element impact location, see sensor designations Sensor 1 (at 64) to Sensor n (at 66), is communicated with a magnetic field response recorder component 68, the latter incorporated into the remote device processor and including any transmitting or other output functionality (at 70) provided for assisting in recording and depicting an impact location of the projectile, such further including, in succession, sub steps for broadcasting a radio frequency RF to electrically excite the sensors, switching to a receiving antenna, acquiring a time history of response radiated from a determined (impacted) sensor or sensors and, as a result, discerning a resonant frequency of response.

Without limitation, the sensor impact/recordation/notification protocols contemplate the ability to read projectile impact locations associated with a single large sensor filling the entire target sheet, as well as smaller sensors of any plurality, such as which can include a projectile impacting boundary locations between two or more grid arranged sensors and which include the necessary protocols for pinpointing the boundary location of impact. As further described with reference to the succeeding figures, it is again understood that the communication protocol established between the detection and communication component of the target sheet sensors and that of the remote processor/response recorder can vary such that the sensor sheet component can simply include the conductive ink tracings which respond to the excitation frequencies resulting from interrogation by magnetic field generation from the response recorder (FIGS. 8A-8B) as well as other variants in which other sensor configurations interface with components associated with an embedded or clip on attachment to the sensor sheet (FIGS. 17A-17C).

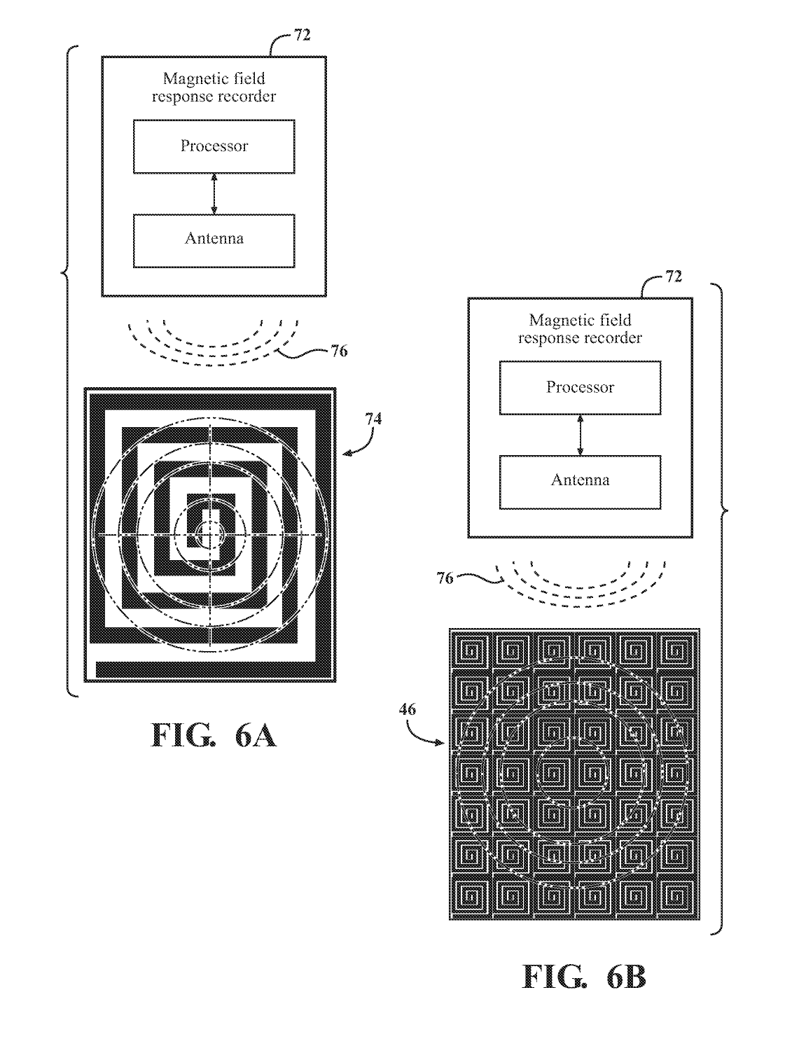

Consistent with the above disclosure, FIGS. 6A and 6B provide a pair of depictions of one simplified arrangement explaining the functionality of the magnetic field response recorder (both at 72) which is alternative to that shown in FIG. 5 and which depicts either of a single sensor element (at 74 FIG. 6A) in use with a target sheet, as well as a plurality of (size exaggerated) elements (again at 46 in FIG. 6B). The magnetic field response recorder, as indicated includes both processor and antenna components for establishing a desired communication (at 76), this again including any of wired or wireless communication protocol between the processor and the detection/communication component of the target sheet, as well as the alternate variant for providing frequency querying (transmitting and receiving) by the processor response recorder with the conductive ink version of the sensor and, in response to a post-impact determination, providing for both detection and output communication to the visual (smart) device associated with the remote processor.

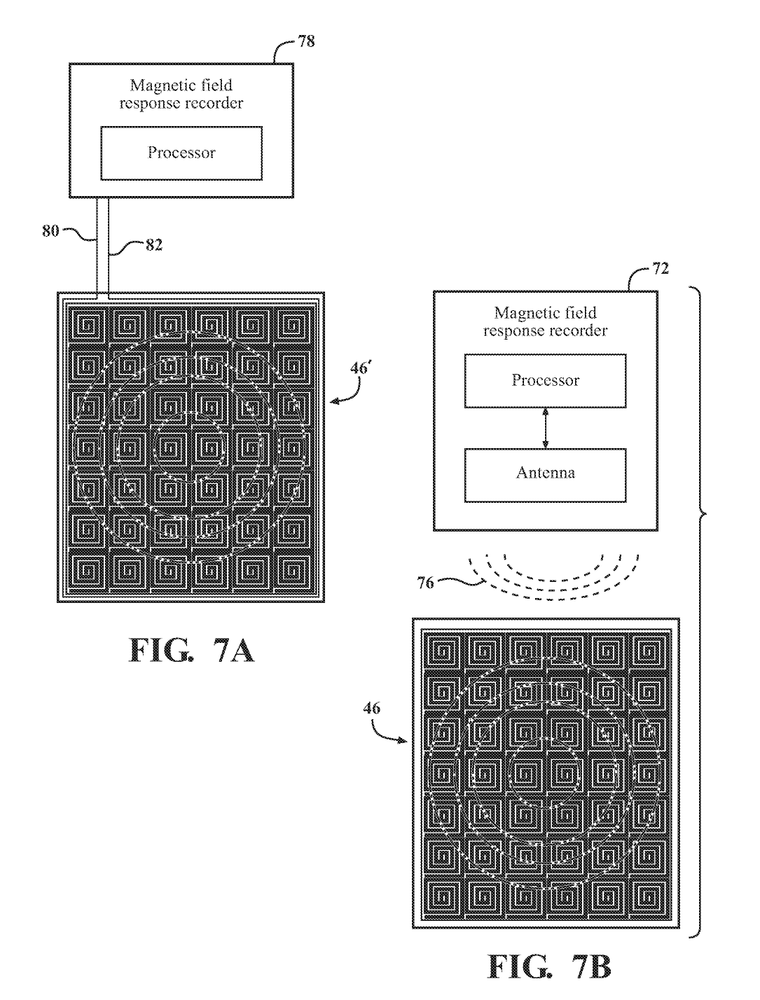

FIGS. 7A and 7B provide additional examples of first and second illustrations of response recorder scenarios. FIG. 7A depicts a simplified arrangement of magnetic field response recorder, at 78 with processor, which is wired directly at 80 and 82 to a modified target sheet 46′. FIG. 7B is provided with embedded antennae (again at 46) for establishing the bi-directional communication 76.

FIGS. 8A and 8B provide a pair of pre-impact 84 and post-impact 86 depictions of a response recorder detection protocol in communication with a selected multi sensor array at 46 by non-limiting representation, such depicting variations in the frequency response component (shown at 88 pre-impact and further at 88′ post-impact) provided to the field response recorder, with location analyzer output 90. As described previously, this version of communication protocol can use a conductive ink or like grid application to the target sheet, with the conductive ink operating as a detection/communication component of the target sheet such that, in response to querying by the remote processor frequency response recorder component such as by the response recorder interrogating the sensor sheet by creating a magnetic field, the frequency read from the sensor array changes at the post-impact location, this information being communicated back to the response recorder (see at 88′ as compared to 88). In this manner, the thin film substrate technologies employed, along with the associated algorithms/machine learning protocols, are able to determine a point of impact and, once the location is detected, the corresponding processor algorithms match the sheet coordinates to the selected target image in order to electronically super-impose the outputted images to the desired visually depicting output devices (again FIGS. 1D-1G).

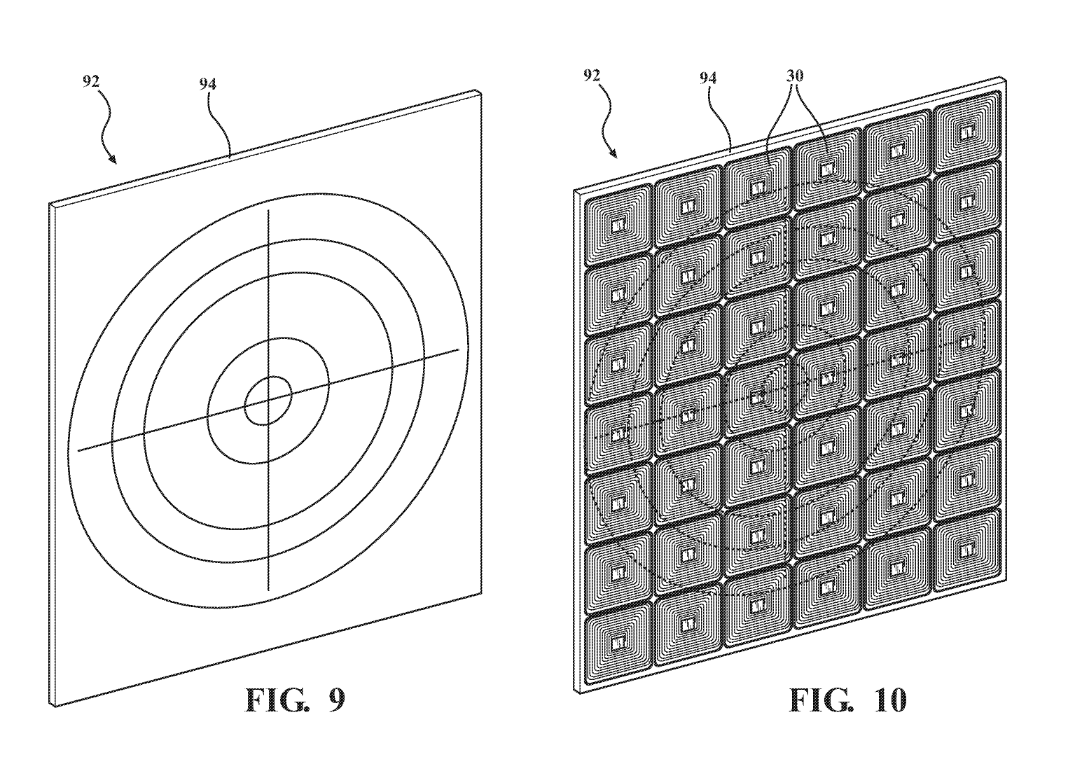

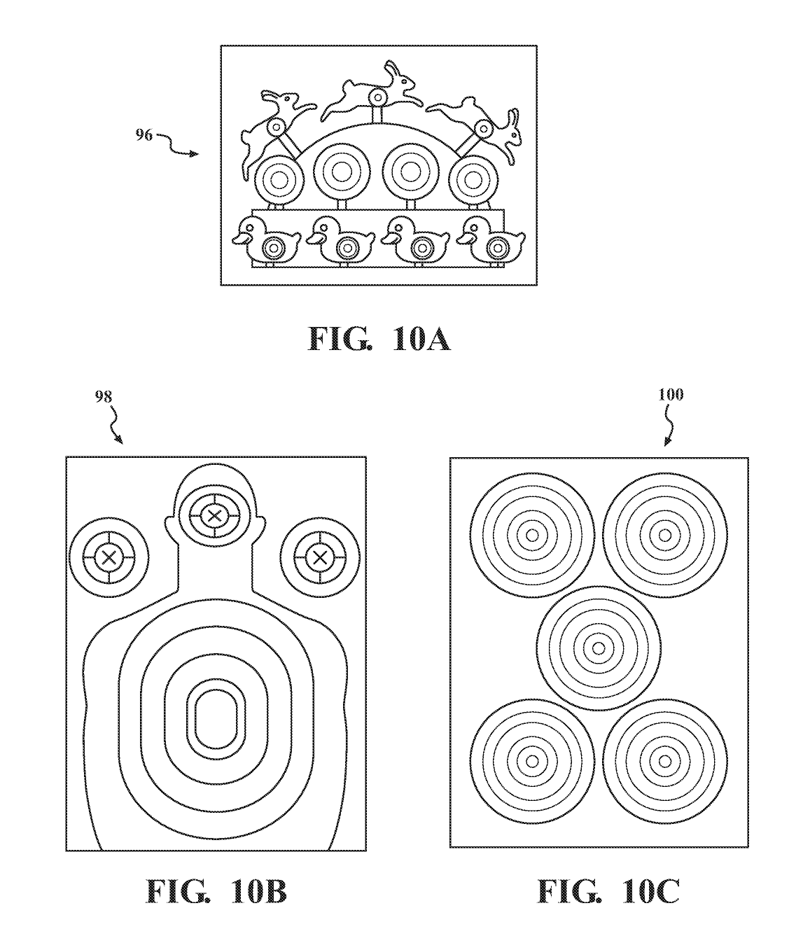

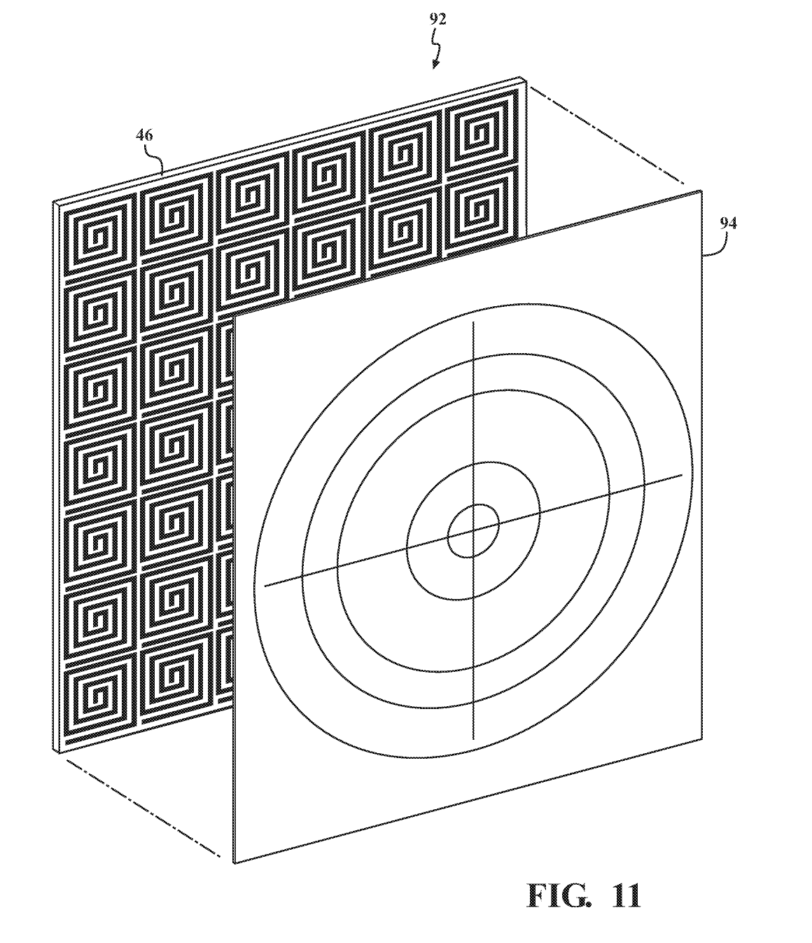

FIGS. 9-10 are front and rear views, respectively, generally at 92 of a single layer target sheet 94 with determined markings overlaying a sensor array base (conductive element sheet or other) of one non-limiting variety, and such as previously shown at 30 in FIG. 10. Related variants can again include the target sheet sensor/sensor array base providing a thin film substrate with embedded sensor(s), the target sheet and printed image (also embedded or conduct ink applied circuits) being superimposed in a single layer, or the target sheet image and sensor/sensor array including location mapping (sensor-image mapping database). Without limitation, the target illustration 92 of FIGS. 9-10 can include a single thin film substrate, paper, bucky sheet or other target layer having a target image printed on a front surface (FIG. 9), the sensor or sensor array being printed on an opposite rear or back surface (FIG. 10).

FIGS. 10A-10C further provide illustrations of varying examples, respectively at 96, 98 and 100, of target sheet size and layout configuration, each of these again provided via sensor image coordinate mapping capabilities and which can include multiple and separate subset target locations such as multiple circular profiles, human or animal outlines, or the like.

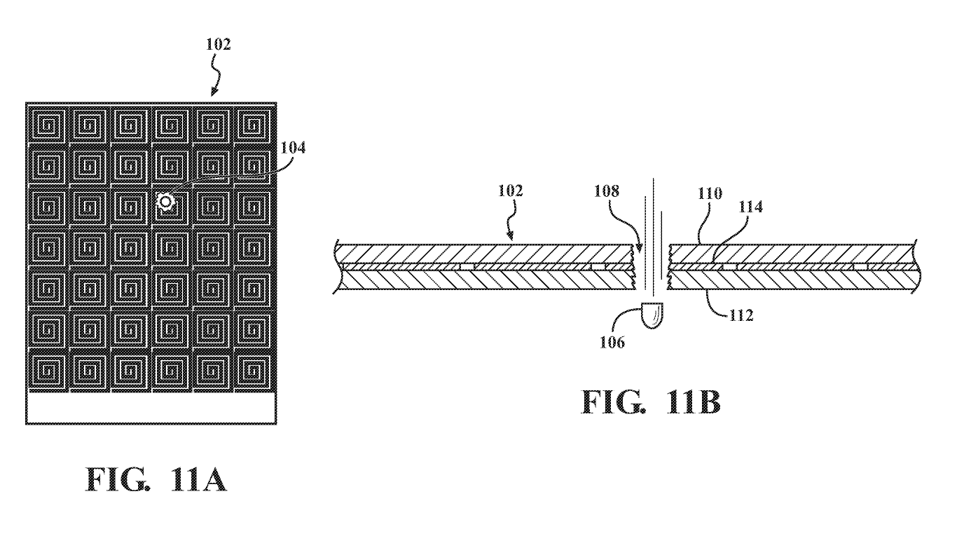

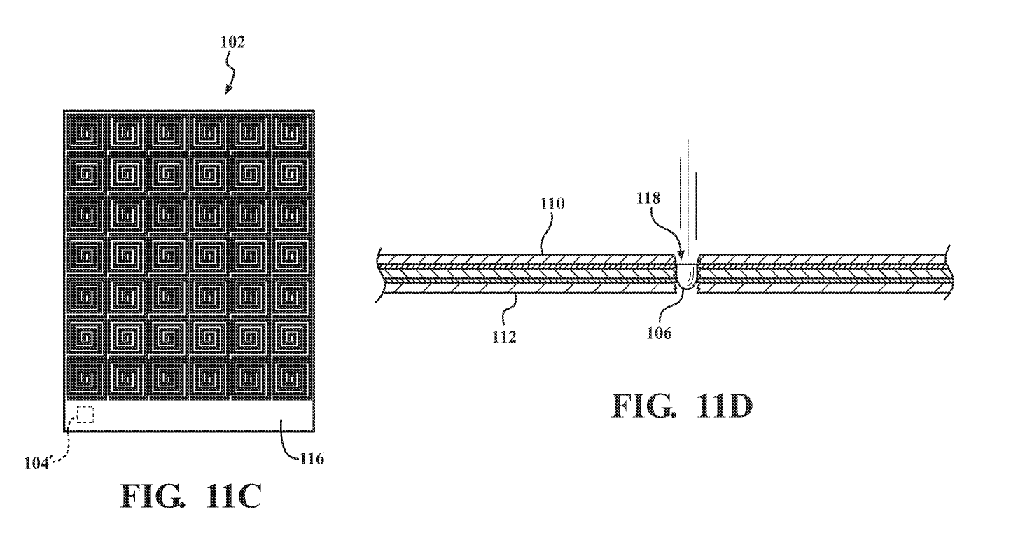

FIG. 11 is an illustration of a target sheet (at 92′ as compared to as previously depicted at 92 in FIGS. 9-10) which can include the sensor sheet as also previously shown at 46 being provided as a separate attachable layer adhered to a reverse side of the target sheet 94 in a two layer arrangement.

FIG. 11A illustrates a further target sheet 102 with a designated impact location 104 within the sensor grid array. FIG. 11B is a side partial and cutaway view of the impact location depicted in FIG. 11A of the given sensor element and referencing a projectile (bullet 106) passing through the sensor sheet 102 (see excised or removed location 108 corresponding to where bullet 104 engages through the sheet) and by removing the thickness of the sensor sheet having spaced outer contact layers 110/112 with the sensor layer 114 interposed between (also referenced by sheet 102) in order to instruct the location of impact via the determined type of field recorder.

FIG. 11C is an illustration of a variation of the target sheet of FIG. 11A (see at 102′) exhibiting an adaptation for supporting multi-shot, single location detection and which additionally includes an outer strip 116 or perimeter edge (non-grid location support) such as including an integrated piezo film, or other component for providing detection of a shot (shown by impact location 104′ landing outside of the sensor grid array. FIG. 11D illustrates a non-grid sensor impact location 118 (see again impact location 104′) of a projectile corresponding with the representation in FIG. 11C and in which the outer piezo film or other material provides multi-layer circuit completion by the projecting bridging the spaced apart sheet conductive layers 110 and 112 (and without the interposed sensor layer 114 corresponding to sheet 102). As depicted, FIG. 11D can also reference an outside location where a previous projectile pass-through has already occurred).

Without limitation, the motivation behind the sensor options depicted in FIGS. 11C-11D is to assist in detecting an overall impact/significant movement of a shot as in the case of it being outside the designated target area (i.e., the target image superimposed over the sensors elements) or, alternatively, in the instance of a second projectile/bullet passing through a same location as a previous bullet (again FIG. 11D) and by which the associated processor can determine the firing of a shot without sheet recordation by any of the previously described protocols. In this variant (bullet enters exact location of a previously made hole), the sensor would already be affected and likely not show/detect the second shot at the same location.

In the above instance, the related processor aspects of the system and computer executable instructions can include adding one or more other sensors in order to identify any significant or sudden sheet motion/impact outside of the target area and so that such general sheet disturbances/impact an be detected, and from which a user configurable algorithm can determine how to record the impact, including scoring. Other options can include the thin conductive layers (again at 110/112) for creating a circuit for identification when the bullet passes/touches both layers.

FIG. 12 is a system process overview flow diagram, generally at 120 of a target and range management protocol incorporated into the present system, process and processor enabled-computer readable medium and covering each of session setup 122, acquisition (impact event recording) 124 and post session 126 (date compilation, storage and presentation) subset functions. Reference is made to the detailed wording provided under each of the individually identified steps for each of the subset protocols identified in FIG. 12, these most broadly including as follows:

For setup session 122, in succession, each of placing target sheet on target board and identify sheet ID, type, etc. (at 128), associating and initializing target and session with any of processor enabled readout device (smart phone, smart watch or in-house range management system at 130), map target layout referencing target sheet database 132, and initiate target mode and acquire environmental information (at 134).

For acquisition subset 124, succeeding steps include (again abbreviated with reference again being had to the specific wordings provided in each subset step providing successive protocols of the overall schematic) each of firing shot (at 136), acquiring target sheet sensor changes identified by response recorder and analyzer 138, determining, recording, transmitting, etc., coordinates (or location values determined) and other acquired data 140, receiving system (devices, system manager) for performing routes to display impact location 142, shot display (visualized on user interface monitoring device) 144, performing support analyses (e.g., shot by shot scoring) at 146, providing performance feedback mechanism (visual, audio, vibratory including in dynamic or biometric input aspects as subsequently described) to device (e.g., iPhone or iWatch) at 148 and completing shooting mode at 150.

The post session subset protocols 126, in succession to the startup 122 and acquisition 124 subset protocols, further include data storage step 152 (for later replay, review and analyses), summary statistic step 154, visual image of performance step 156 and session-to-session comparison step (158) for comparing separate sessions.

FIG. 13 is a further flow diagram, generally at 160, of system components associated with the target and range management functions of the present invention and including each of target location detection and identification subset features or protocol 162, target acquisition systems subset features 164, collection inputs/devices features 166, user interface(s) subset features 168, and system control/management subset protocol or features 170. Also referenced are each of data management step 172 and analytics recording step and reporting functions 174.

In the interest of brevity and clarity, reference is made to each of the individual subset steps 176-210 identified for each subset feature or protocol and the specific wordings and identifications of each presented in FIG. 13 are hereby incorporated by reference. Also, the particular options listed in FIG. 13 draw from additional input, biometric and other dynamic functionalities presented in the subsequent figures and which will be further described.

For target location detection and identification subset features 162, these including subset steps 176 (target sheet), 178 (response recorder), 180 (location analyzer) and 182 (target-shot locator) for target location, detection and identification protocol 162. For subset protocol 164 (target acquisition systems), each of embedded all in one step 184, clipped on detector 186, range interface 188 and separate detector 190 steps are shown.

For collection inputs/devices subset protocol 166, reference is made to each of watch 192, glove 194 and phone/table 196. User interface subset feature functionalities 168 include each of watch 198, phone/tablet 200, and range management 202. System control/management subset functions 170 include each of range based system features 204 and standalone system 206. Finally, data management function 172 includes database 208 (for target images and location mapping as well as shot/session recording) and analytics recording and repeating function 174 includes features 176 covering each of data recording and storage, shot sequence/timing/time intervals, etc., shot scoring, grouping, etc., input device(s) associated data (e.g., environmental), results/reporting and user metrics. Again all of wording presented in each of the subset identifications in the individual subset blocks 176-210 of FIG. 13 are incorporated by reference into the present description.

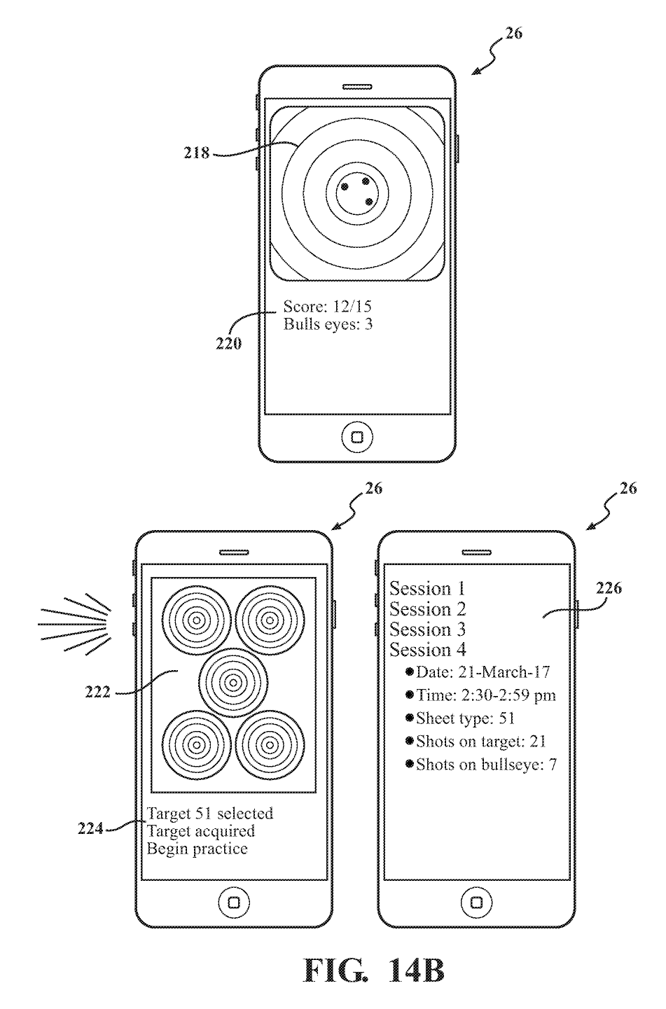

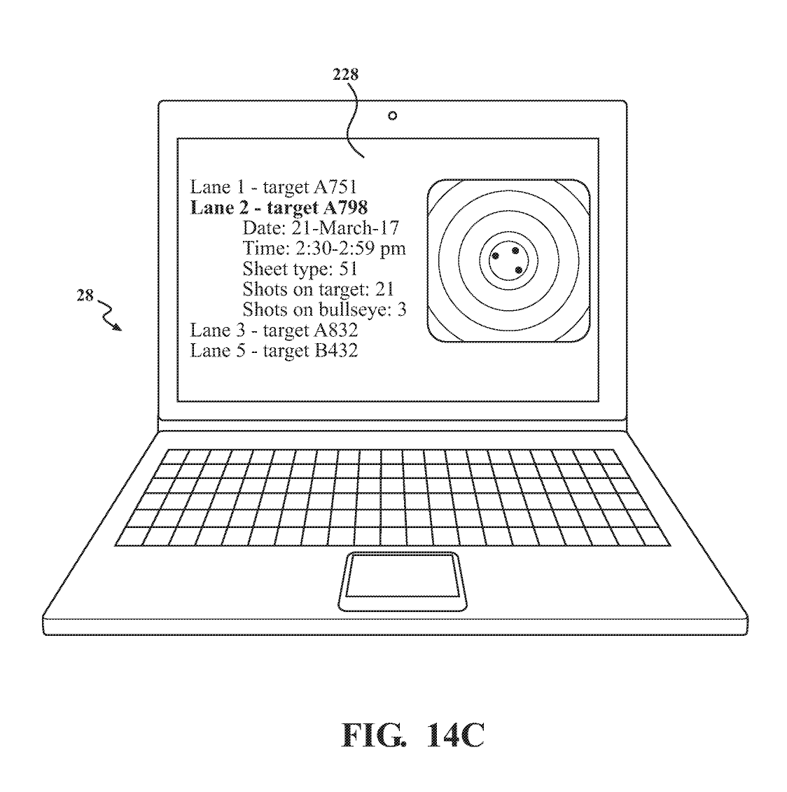

FIG. 14A provides a pair of pre and post impact representations of a target depiction on such as a processor enabled and wirelessly communicating smart watch 24 (see also again FIG. 1E). The smart watch can also have an acquisition mode (see at 212) which can be selectively activated or deactivated. The configurable aspects of the device, drawing from known capabilities, include the ability to start/stop each session and to provide vibration, sound, flash, etc. (at 214) as instructed by the processor and in response to any of a determined hit/miss of the target. The device smart watch or other) may also acquire information from any built in accelerometer, barometer, microphone, etc., such as in order to identify the user's hand steadiness (such as exhibited when the shot is fired). Output identification of shot placement may also be provided on the device and as identified by readout 216 (e.g., Location 2″L-1.5″D).

FIG. 14B provides a series of depictions of event representations upon a mobile phone (see also at 26 FIG. 1D) and including each of target depiction 218 and score readout (e.g., Score: 12/15-Bulls eyes: 3) 220. Also depicted is separate target depiction 222, a control platform illustration (e.g., Target 51 selected, target acquired and Begin Practice 224) and a data output compilation (Sessions 1-4 with each providing Date, Time, Sheet Type, Shots on target and Shots on bullseye).

FIG. 14C provides a further depiction similar to FIGS. 14A-14B utilizing any of a laptop or desktop processor controlled and connected device, again at 28 as shown previously in FIG. 1G). A screen depiction 228 identifies an example of a multi-shoot control platform (e.g., such as used on a shooting range) and providing individualized target information for each of a plurality of lanes with highlighted individualized subset/drop down functions for a given lane and target (e.g. Date, Time, Sheet Type, Shots on target and Shots on bulls eye).

Each of the processor and visual readout devices utilized can include any wired or wireless functionality not limited to RFID (radio frequency identification), Bluetooth, ZigBee, WiFi or other known communication protocols. These can be further associated with any known smartphone, smart watch or tablet/processor device (including iOS or Android based) and can operate at distances consistent with known shooting ranges.

The selected communication protocol can additionally provide communication back to a central recording, viewing and monitoring system (additional to such as any of the personal devices in FIGS. 1D-1G), the central recording system can again be a PC device corresponding to the laptop 28 and which can also be provided as a second or different laptop/desktop or other central processor operating in this capacity such as when the user may not have or wish to use a supporting smart phone, smart watch or tablet. During the shooting practice session, the target sheet is activated (such as by the field response recorder as previously described) and then transmits to the central processor/controller session information inputs for each of storage, analysis, replay and printout (see again FIGS. 12-13). The central controller can further provide an end of shooting performance summary via print, web access or the like.

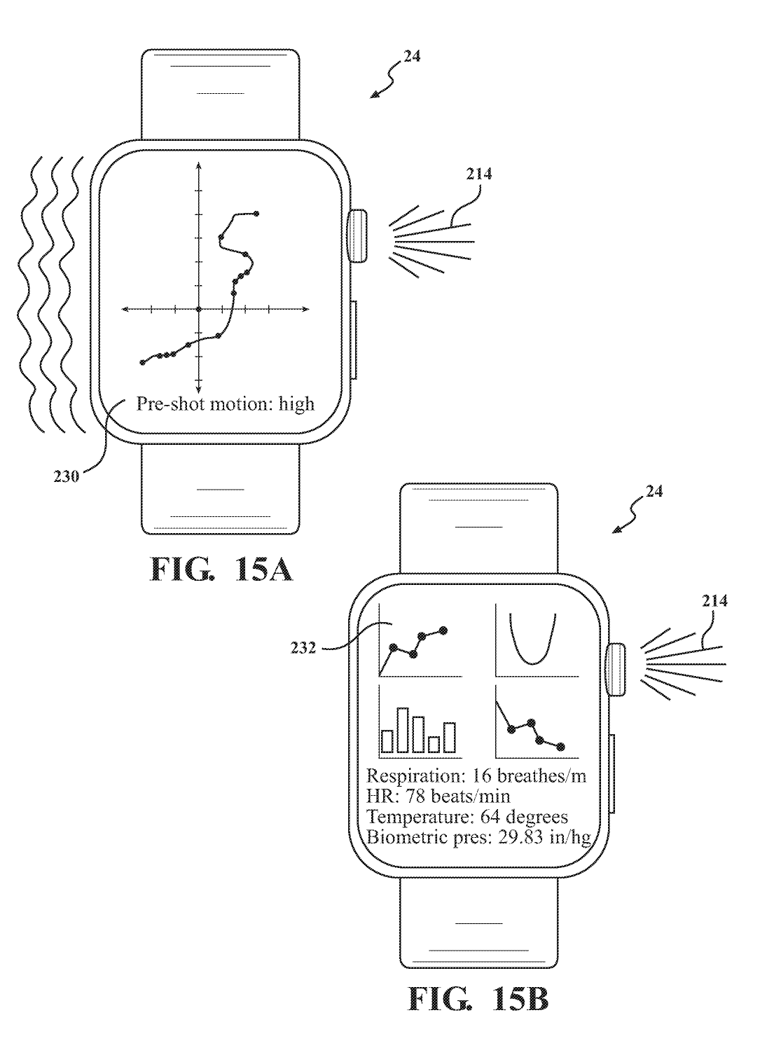

FIGS. 15A-15B illustrate a pair of depictions of integrated biometric sensors and readout functionality, such as again in use with an smart watch 24 and providing each of motion tracking (pre shot at 230 and post shot at 232), along with biometric and environmental measurements which can be synchronized with any version of the targeting and display system for proving visual, auditory and haptic feedback of real time results of ballistic impact on the target positioned sensor sheet and collecting shooter and environmental information. The pre-shot readout 230 in FIG. 15A can include a visual designation, such as “Pre-shot motion: high”, with the post-shot readout 232 in FIG. 15B providing a range or plurality of readouts both graphical as well as literary, e.g. listing each of respiration, heart rate, temperature and biometric pressure (such as at grip location).

The integrated biometric sensor aspects depicted are again understood to combine the functionality of the known device with the particular protocols programmed or designed into the control platform and which provide for time synchronization with each shot. These may further include monitoring, reporting and data compiling for each of respiration, heart rate/pulse, blood pressure, electromyography, sweat/epidermal activity, etc.; motion detection (xyz plane motion), acceleration, measurement of gravity (or g) forces from shot, feedback when steady to support training (accelerometer); pressure detection (identifying shot occurrence); sound, vibration, etc. output (see again at 214) or other notification to instruct the user when performing correctly or incorrectly; providing summary graphs (consolidated/summation metrics); and device-based acquisition and other integrated sensor functionality. In this fashion, the device output can provide any type or range of motion, pressure and/or physiological readout metrics relating to the shooter to complement those pertaining merely to shot placement/accuracy.

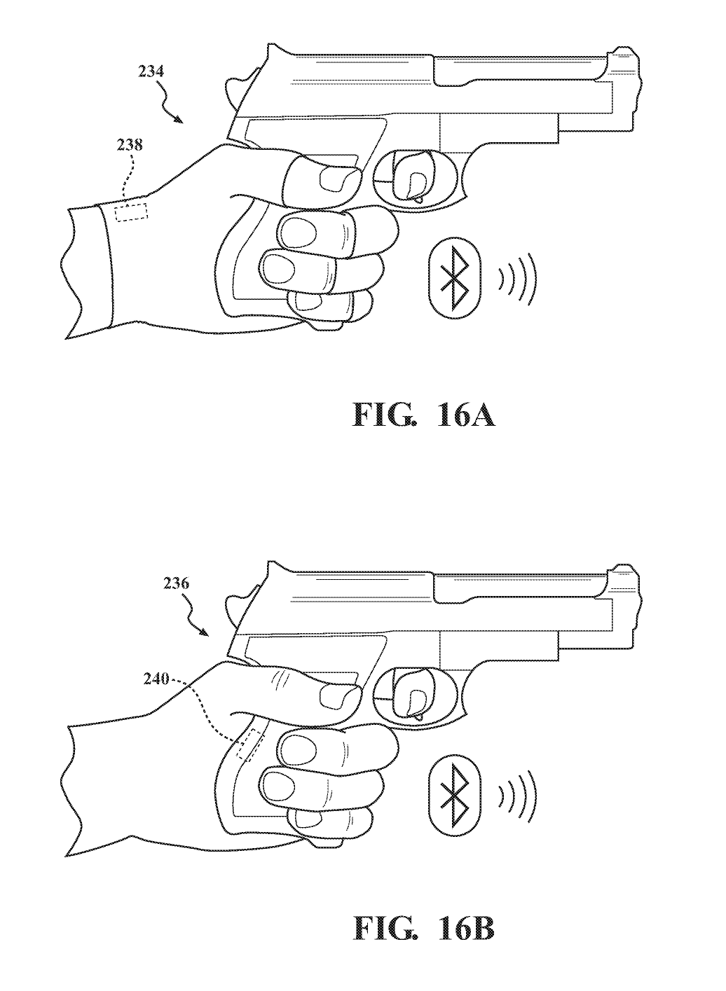

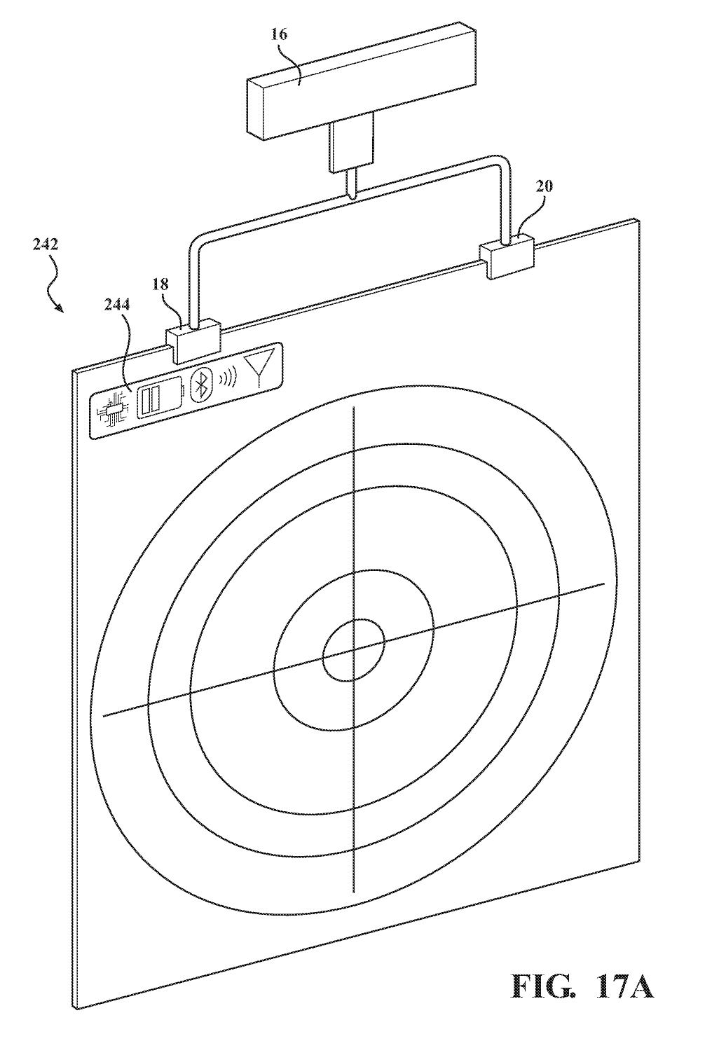

FIGS. 16A-16B illustrate a pair of depictions of a biometric enabled glove (at 234 in FIG. 16A) and a sensor enabled gunstock (at 236 in FIG. 16B) for providing any one or more of respiration, heart rate, blood pressure, electromyography, epidermal (sweat) activity, motion detection, pressure detection, RFID, Bluetooth, ZigBee, ANT, WiFi, sound, vibration and summary graphs. The glove variant 234 (FIG. 16A) includes a sensor or the like at 238 for providing readout of a grip pressure, gun motion or physiological measurement of the shooter, such consistent with the biometric and physiological measurement capabilities built into the present assembly, process and protocols. As further shown in FIG. 16B, the sensor or like component is reconfigured, at 240, into the gun stock of the firearm, such as in proximity to a user grip location for again providing the desired grip pressure or other physiological measurement. Without limitation, other sensors (not shown) can provide a readout for such as a band tension in the instance of a smart watch worn by the shooter and which can be communicated by BlueTooth or other near field communication protocols to either or both the user/shooter processor device or remote controller/processor.

FIG. 17A is an illustration, at 242, of a target acquisition configuration including a single use target (see also as previously depicted at 10 and 10′ in FIGS. 1A and 1C) with integrated/embedded power, detection and communications functionality (at 244 and such as which can be associated with one possible and non-limiting type of detection and communication component associated with the target sheet) and utilizing all of the features and functions previously described.

FIG. 17B is an illustration of a further variant of a target acquisition configuration, at 246, in the form of an alternate detection/communication interface component 248 which is clipped onto the target sheet, such including a single use target with battery powered reusable detection and communications device.

FIG. 17C is a yet further illustration of another variant of a target acquisition configuration with built-in range target retrieval interface, such as including a single use target with permanent, powered detection and target sheet detection and communication component 252 (this substituting for the self-powered pairing and transmitting device 16). The upper most positioned component 252 can have clips 251 engaged to an overhead bi-directionally linearly actuating carriage or trolley 253 for bi-directionally advancing or retreating the target sheet assembly as shown.

In each instance, the items depicted can again include any combination of sensor(s), thin film substrate, printed target image, thin film battery (FIG. 17A), miniature Bluetooth, ZigBee, etc., communications (FIG. 17A), miniature chip processor (FIG. 17A), connection leads to clip on transmitting unit with battery and wireless communications (FIG. 17B) and other connection leads to permanent, powered connection interface on the range target equipment (FIG. 17C).

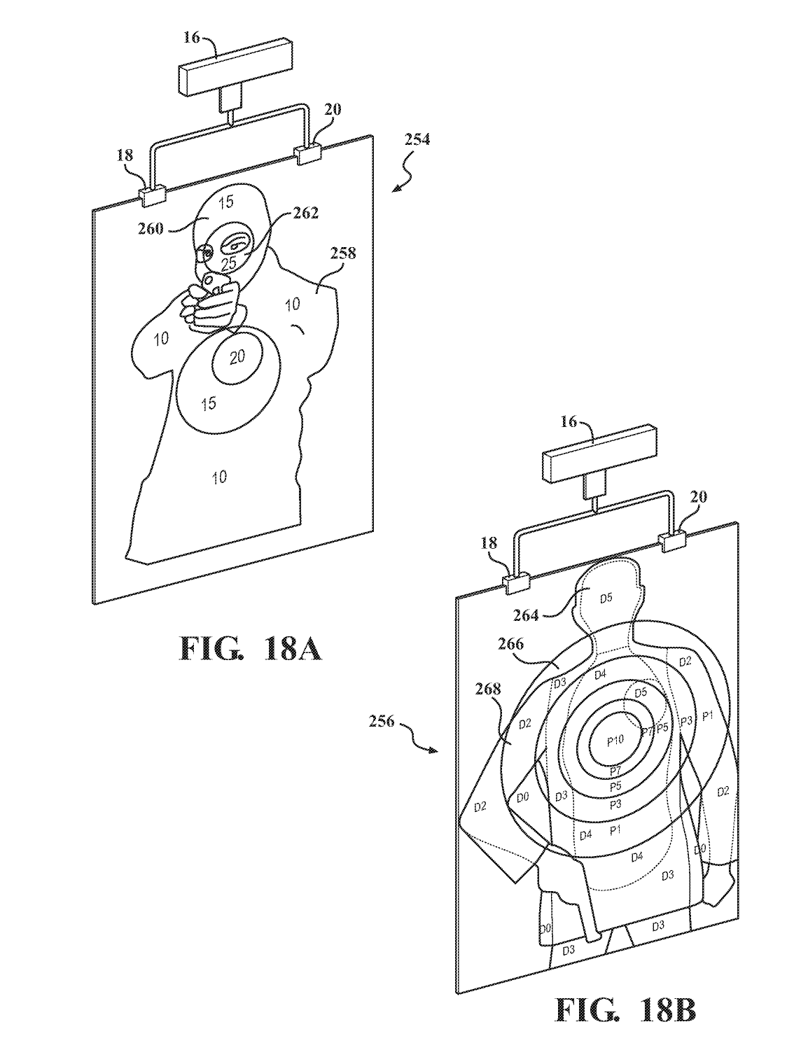

FIGS. 18A and 18B provide a pair of exemplary dynamic image projection target displays, see at 254 and 256 respectively, either such integrating any of the functionalities depicted in FIGS. 17A-17C and which can be utilized in combination with the biometric and input sensor functionality of FIGS. 15A-16B for use in such as a dynamic target practice or like exercise. More particularly, the depictions 254 and 256 each provide a varied image which can be dynamic (projected and changing) and which can include value point location indications (see in FIG. 18A at 258, 260, 262, et seq.) for shot placement, as well as other numeric location indications (at 264, 266, 268 in FIG. 18B).

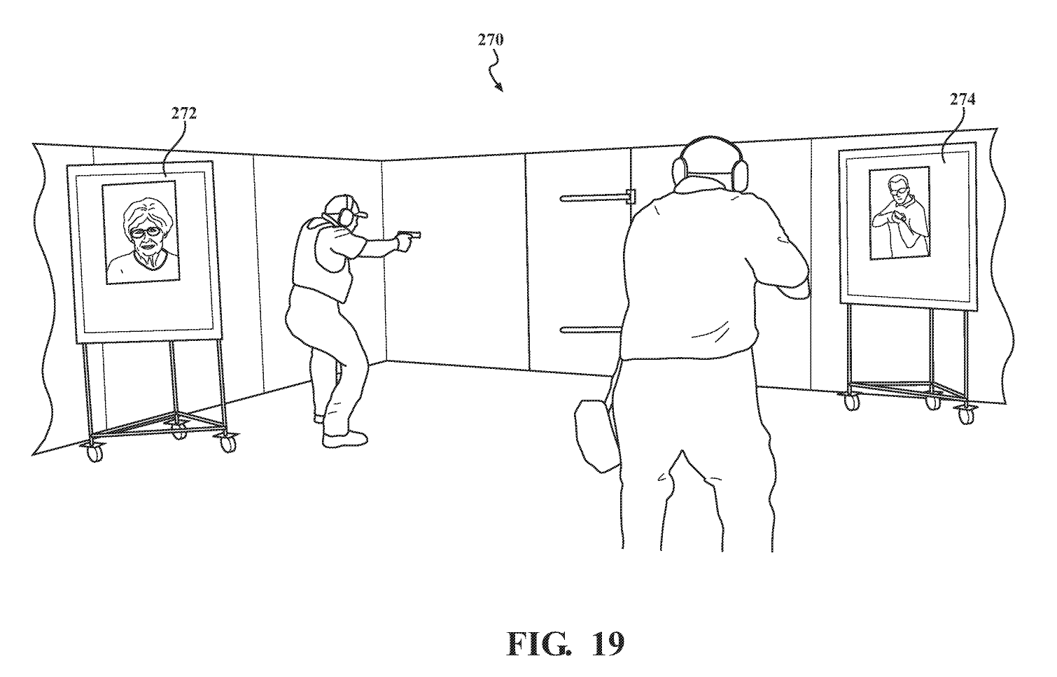

FIG. 19 is an environmental illustration, at 270, of a dynamic target image projection and acquisition scenario utilizing the displays of FIGS. 18A-18B and including time synchronized projected image changes with target impact identification capabilities for simulating and recording participant performance with such as random friend/foe changes in the target representations. Without limitations, the target depictions (shown statically supported upon repositioning rollers at 272 (friendly depiction) and 274 (foe depiction) but including any movable target such as upon a trolley or other carriage component) can be deployed in a multi-shooter environment (at 2 and 2′) for training in such as live shooter situations, both military and law enforcement. The ability to combine and synchronize the dynamic and changing image projections (again such depicting friend or foe) with the shot placement and biometric readout aspects can provide enhanced and more comprehensive rating capabilities than currently possible with existing training equipment and capabilities.

In operation, and according to any of the afore-mentioned embodiments described, the thin film (substrate) sensor(s) or like technologies, along with the location and detection/determination algorithms(s), are able to determine location of impact of the ballistic. As understood from current sensor technologies, a processing/analyzer unit may be required with algorithms which work in coordination with the sensor interrogation process(es) for assisting in determining impact location. Once the location is detected, an associated programming algorithm matches the sheet or insert coordinates to the selected target image and then electronically super-imposes the same as an output image displayed upon any viewing display of a processor driven device (smartphone, smartwatch, tablet, laptop, etc.). To this end, the sheets can each have unique IDs for identification and association with the detection interface. One exemplary target sheet image and ballistic impact location matching process would be to access the sheet's image identifier and then retrieve the previously mapped image details, coordinates, etc. from an image database.

The Acquisition mode depicted in subset at 124 in FIG. 12 again includes each of discharging the ballistic projectile, coordinating the point of impact on the target sheet and transmitting the coordinates (or location of the values to be transmitted). The processor and related functionality incorporated into the remote device (smartphone, smartwatch, laptop, tablet or other) performs the necessary calculations to display the point of impact. The impact is then displayed on the monitor or screen of the device, concurrent with the associated control platform and algorithm performing any desired analysis (e.g., shot by shot scoring), and/or depending on the device provide auditory, vibrational/haptic, etc. performance-related feedback to the user. Additional controller functions include providing other comparison and analysis metrics to the remote processor device and prior to completing the shooting mode.

The control metrics (including post session subset protocols 126) can further be integrated into aspects of the post shooting session which can include data storage for later replay, review and analysis, along with providing each of summary statistics, visual images of performance and session to session comparisons.

The present invention also envisions including any type of thin film batteries, miniaturized communication components (miniature processor and Li ion battery) and varying target configurations/target mapping consistent with the descriptions previously provided. The present invention further envisions combining any aspect of a sensor integrated target, an associated and algorithmic controlled platform, a wired or wireless data transfer protocol and a remote processor driven and audio/visual/vibration display device for providing real time output (such as to the shooter) of the results of the target practice. Related aspects of the control platform can also provide any or all of data replay, review and analysis, summary statistics, visual images of performance and session to session comparisons.

Additional considerations can include providing an accelerometer and audible sensor embedded in sheet form for shot confirmation purposes and detection of a shot in an existing hole.

Additional versions include where a customer could utilize the target insert sheets without a smart watch or smart phone, with such ballistic impact information being communicated back to a central PC for recording, printing, web-site upload, etc. This main control center could in this instance be operated by the range personnel assigning sheets, recording, archiving, uploading to web, printing out end of session results and analytics, etc.

The biometric input information again gathered from the user/shooter can be acquired and time synced with the recorded shots to indicate pre-shot steadiness, confirmation of shot (e.g., significant movement, loud sound, pressure changes), environmental conditions, etc. The system can even acquire information via weather service and sync to system.

Other features include adding the use of image projection or holographic images onto sheets, such as to time sync the changing of images with shot detection for simulation purposes and user response to varied friend and foe situations. Additional and optional aspects include the ability of the present system and processor controlled computer method to capture any of the audio/noise component associated with the projectile, firearm recoil, or other via the processor device (including a user smart device) for timing purposes such as shot detection and/or syncing with sheet detection.

Having described my invention, other and additional preferred embodiments will become apparent to those skilled in the art to which it pertains, and without deviating from the scope of the appended claims.

I claim:

1. A computer assisted system for providing real time feedback of a ballistic impact, comprising:
a target utilizing a sensor sheet;
a detection and communication component in communication with said sensor sheet;
a processor device incorporating a response recorder in communication with the detection and communication component for identifying and recording a ballistic impact in the sensor sheet; and
a non-transitory computer readable medium embodying computer-executable instructions which, when executed by the processor device, outputs a visual depiction of shot placement.

2. The invention as described in claim 1, the detection and communication component including any of inductor/capacitor sensor systems, passive RFID tags, carbon nanotube, graphene or Bucky paper.

3. The invention as described in claim 1, said processor device including any of a mobile application enabled smartphone, smartwatch, laptop, tablet or other digital and audio/visual display device.

4. The invention as described in claim 1, the sensor sheet further comprising at least one sensor element which, in response to an impact by the ballistic, results in a signal corresponding to a location associated with a selected location of ballistic impact.

5. The invention as described in claim 1, the sensor sheet further comprising a material upon which is imprinted a circuit pattern.

6. The invention as described in claim 1, further comprising a printed image upon the sensor sheet.

7. The invention as described in claim 4, the detection and communication component further comprising a mini-chip processor incorporated into the sheet communicating with a transmitter.

8. The invention as described in claim 1, further comprising a wireless communication protocol for transmitting data to the device.

9. The invention as described in claim 8, the wireless protocol including any of a Bluetooth, Near Field Communication, ZigBee, WiFi or other protocol.

10. The invention as described in claim 7, further comprising a battery for powering the mini-chip processor and transmitter.

11. The invention as described in claim 1, the non-transitory computer readable medium embodying computer-executable instructions further comprising an algorithmic protocol for providing data additional to real-time point of impact and including any of replay, review and analysis, summary statistics, visual images of performance and session to session comparison.

12. The invention as described in claim 1, the sensor sheet further comprising a circuit array encompassing any of wiring, printed or embedded circuits, and conductive ink circuits.

13. The invention as described in claim 1, the non-transitory computer readable medium embodying computer-executable instructions further comprising measuring of any biometric or physiological input of the shooter.

14. The invention as described in claim 13, the processor device further comprising a visual communicating device incorporating any of auditory, visual, or vibrational/haptic output capabilities.

15. The invention as described in claim 1, the computer executable instructions further comprising varying any of projected, holographic, or other images on a substrate of the target in a time synchronized fashion according to a training scenarios.

16. The invention as described in claim 1, further comprising said response recorder operating on any of a frequency or magnetic field protocol.

17. The invention as described in claim 1, said sensor sheet further comprising at least one individual sensor element arranged in a grid with a target superimposed over the grid.

18. The invention as described in claim 2, further comprising the detection and communication component being embedded into the sensor sheet.

19. The invention as described in claim 2, further comprising the detection and communication component being clipped onto the sensor sheet.

20. A computer implemented method providing real time feedback of a ballistic impact, comprising the steps of:
providing a target utilizing a sensor impregnated sheet incorporating a detection and communication component;
providing a processor device incorporating a response recorder in communication with the detection and communication component for identifying and recording a ballistic impact on the sensor sheet; and
providing a non-transitory computer readable medium embodying computer-executable instructions which, when executed by the processor device, outputs to the processor device a visual depiction of shot placement.
